(19) United States
(12) Patent Application Publication
(10) Pub. No.: US 2006/0159325 A1
(43) Pub. Date: Jul. 20, 2006

(54) System and method for review in studies including toxicity and risk assessment studies

(75) Inventors: Jack A. Zeineh, Fullerton, CA (US); Geoffrey J. Hueter, San Diego, CA (US); Robert D. Teegarden, Mission Viejo, CA (US)

Correspondence Address: THE LAW OFFICE OF RICHARD W. JAMES, 25 CHURCHILL ROAD, CHURCHILL, PA, 15235, US

(73) Assignee: Trestle Corporation

(21) Appl. No.: 11/348,768

(22) Filed: Feb. 7, 2006

Related U.S. Application Data
(63) Continuation-in-part of application No. 11/334,138, filed on Jan. 18, 2006.
(60) Provisional application No. 60/651,129, filed on Feb. 7, 2005.
(60) Provisional application No. 60/647,856, filed on Jan. 27, 2005.
(60) Provisional application No. 60/651,038, filed on Feb. 7, 2005.
(60) Provisional application No. 60/645,409, filed on Jan. 18, 2005.
(60) Provisional application No. 60/685,159, filed on May 27, 2005.

(51) Int. Cl. G06K 9/00; G06F 19/00

(52) U.S. Cl. 382/128; 705/3

(57) ABSTRACT

Systems and methods for reviewing and managing toxicology and risk assessment studies, including the reviewing of specimen images.

### CROSS-REFERENCE TO RELATED APPLICATIONS

This application claims priority to copending U.S. Provisional Application Nos. 60/651,038, filed Feb. 7, 2005; 60/651,129, filed Feb. 7, 2005; and 60/685,159, filed May 27, 2005; and this application is a continuation-in-part of U.S. patent application Ser. No. 11/334,138, filed Jan. 18, 2006, which claims priority to U.S. Provisional Application Nos. 60/651,129, filed Feb. 7, 2005; 60/647,856, filed Jan. 27, 2005; 60/651,038, filed Feb. 7, 2005; and 60/645,409, filed Jan. 18, 2005; and 60/685,159, filed May 27, 2005.

### STATEMENT REGARDING FEDERALLY SPONSORED RESEARCH

Not applicable.

### BACKGROUND

Imaging systems are used to capture magnified images of specimens, such as, for example, tissue or blood. Those images may then be viewed and manipulated, for example, to diagnose whether the specimen is diseased. Those images may furthermore be shared with others, such as diagnosticians located in other cities or countries, by transmitting the image data across a network such as the Internet. Needs exist, however, for systems, devices and methods that efficiently capture, process, and transport those images, and that display those images in ways that are familiar to diagnosticians and that make the diagnosis process less time consuming and less expensive.

### BRIEF DESCRIPTION OF THE DRAWINGS

The accompanying drawings, wherein like reference numerals are employed to designate like components, are included to provide a further understanding of an imaging and imaging interface apparatus, system, and method, are incorporated in and constitute a part of this specification, and illustrate embodiments of an imaging and imaging interface apparatus, system, and method that together with the description serve to explain the principles of an imaging and imaging interface apparatus, system and method.

In the drawings:

FIG. 1 is a flow chart of an embodiment of a process for creating and reviewing a tissue;

FIG. 2 illustrates an embodiment of an image management system;

FIG. 3 is a flow chart of an embodiment of a method that may be utilized in a computerized system for diagnosing medical specimen samples;

FIG. 4 is a flow chart of an embodiment of a method for providing a quality assurance/quality control (“QA/QC”) system;

FIG. 5 is a flow chart of an embodiment of a method for providing an educational system for diagnosing medical samples;

FIG. 6 illustrates an embodiment of a graphic user interface;

FIG. 7 illustrates an embodiment of a network in which the graphic user interface may operate;

FIG. 8 is a flow chart of an embodiment of a method for creating images of a specimen;

FIG. 9 illustrates an embodiment of an image system;

FIG. 10 illustrates an embodiment of an image indexer;

FIG. 11 illustrates an embodiment of an image network;

FIG. 12 illustrates an embodiment of a process of image feature extraction;

FIG. 13 illustrates an embodiment of an image network;

FIG. 14 illustrates an embodiment of a toxicology and risk assessment study process;

FIG. 15 illustrates an embodiment of a system workflow process;

FIG. 16 illustrates an embodiment of a log in screen;

FIG. 17 illustrates an embodiment of a home page display;

FIG. 18 illustrates an embodiment of a home page display;

FIG. 19 illustrates an embodiment of a retrieval search tool display;

FIG. 20 illustrates an embodiment of an images only results display;

FIG. 21 illustrates an embodiment of a simple results display;

FIG. 22 illustrates an embodiment of a dynamic results display;

FIG. 23 illustrates an embodiment of a new study display;

FIG. 24 illustrates an embodiment of a file browse control display;

FIG. 25 illustrates an embodiment of a compare option display;

FIG. 26 illustrates an embodiment of an annotation option display;

FIG. 27 illustrates an embodiment of a reconcile option display;

FIG. 28 illustrates an embodiment of a case list display;

FIG. 29 illustrates an embodiment of a case details display;

FIG. 30 illustrates an embodiment of an image viewing display;

FIG. 31 illustrates an embodiment of an image compare display; and

FIG. 32 illustrates an embodiment of an administrator statistics screen.

### DETAILED DESCRIPTION

Reference will now be made to embodiments of an imaging and imaging interface apparatus, system, and method, examples of which are illustrated in the accompanying drawings. Details, features, and advantages of the imaging and imaging interface apparatus, system, and method will become further apparent in the following detailed description of embodiments thereof.

Any reference in the specification to “one embodiment,” “a certain embodiment,” or a similar reference to an embodiment is intended to indicate that a particular feature, structure or characteristic described in connection with the embodiment is included in at least one embodiment of the invention. The appearances of such terms in various places in the specification do not necessarily all refer to the same embodiment. References to “or” are furthermore intended as inclusive, so “or” may indicate one or another of the ored terms or more than one ored term.

As used herein, a “digital slide” or “slide image” refers to an image of a slide. As used herein, a “slide” refers to a specimen and a microscope slide or other substrate on which the specimen is disposed or contained.

The advent of the digital slide may be thought of as a disruptive technology. The analog nature of slide review has impeded the adoption of working methodologies in microscopy that leverage the efficiencies of information and other computer technology. A typical microscope user who views slides, such as an Anatomic Pathologist, may have a text database for viewing information about the slides being reviewed and may use that same information system to either dictate or type notes regarding the outcome of their review. Any capturing of data beyond that may be quite limited. Capturing slide images from a camera and sending them into a database to note areas of interest may be cumbersome, may increase the time it takes to review a slide, and may capture only those parts of a slide deemed relevant at the time one is viewing the actual slide (limiting the hindsight capability that may be desired in a data mining application).

With availability of digital slides, a missing piece in creating a digital workplace for microscopic slide review has been provided. It has now become possible in certain circumstances for all the data and processes involved with the manipulation of that data to be processed digitally. Such vertical integration may open up new applications, new workplace organizations, and bring the same types of efficiencies, quality improvements, and scalability to the process of anatomic pathology previously limited to clinical pathology.

The process of reviewing glass slides may be a very fast process in certain instances. Operators may put a slide on a stage that may be part of or used with the microscope system. Users may move the slide by using the controls for the stage, or users may remove a stage clip, if applicable, and move the slide around with their fingers. In either case, the physical movement of the slide to any area of interest may be quite rapid, and the presentation of any image from an area of interest of the slide under the microscope objective may literally be at light speed. As such, daily users of microscopes may work efficiently with systems that facilitate fast review of slide images.

Users may benefit from reviewing images at a digital workplace that provides new capabilities, whose benefits over competing workplaces are not negated by the loss of other capabilities. A configuration of digital slide technology may include an image server, such as an image server 850 described herein, which may store a digital slide or image and may send over, by “streaming,” portions of the digital slide to a remote view station. A remote view station may be, for example, an imaging interface 200 or a digital microscopy station 901 as described herein, or another computer or computerized system able to communicate over a network. In another configuration of digital slide technology, a user at a remote site may copy the digital slide file to a local computer, then employ the file access and viewing systems of that computer to view the digital slide.

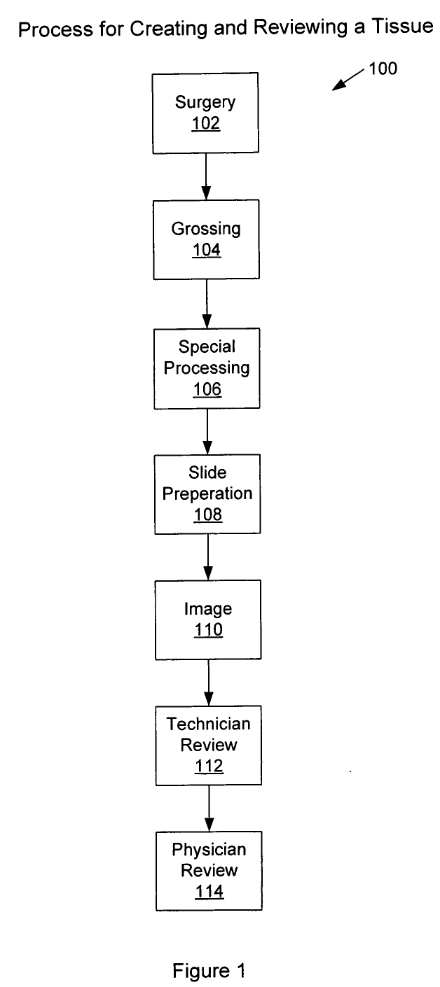

FIG. 1 is a flow chart of an embodiment of a process for creating and reviewing a tissue 100. At 102, tissue is removed or harvested from an organism, such as a human or animal by various surgical procedures, including biopsy and needle biopsy. At 104, grossing is performed, wherein the removed tissue or tissues may be viewed and otherwise contemplated in their removed form. One or more sections may then be removed from the gross tissue to be mounted on a substrate, such as a microscope slide or a microscope stage, and viewed. At 106, special processing may be performed on or in connection with the tissue. One form of special processing is the application of stain to the tissue. At 108, a slide is prepared, generally by placing the tissue on a substrate and adhering a cover slip over the tissue, or by other means. Alternately, a fluid, such as blood, or another material may be removed from the organism and placed on the substrate, or may be otherwise prepared for imaging. Tissue, fluids, and other materials and medical or other samples that are to be imaged may be referred to herein as “specimens.” For example, in various embodiments, a specimen may include a tissue sample or a blood sample.

At 110, the slide may be imaged. A slide may be imaged by capturing a digital image of at least the portion of the slide on which a specimen is located as described in U.S. patent application Ser. No. 09/919,452 or as otherwise known in the imaging technologies. A digital slide or image of a slide may be a digitized representation of a slide (and thus a specimen) sufficient to accomplish a predefined functional goal. This representation may be as simple as a snapshot or as complex as a multi-spectral, multi-section, multi-resolution data set. The digital slides may then be reviewed by a technician to assure that the specimens are amenable to diagnosis at 112. At 114, a diagnostician may consider the digital images or slides to diagnose disease or other issues relating to the specimen.

In one embodiment, a system and method is employed, at 110, for obtaining image data of a specimen for use in creating one or more virtual microscope slides. The system and method may be employed to obtain images of variable resolution of one or more microscope slides.

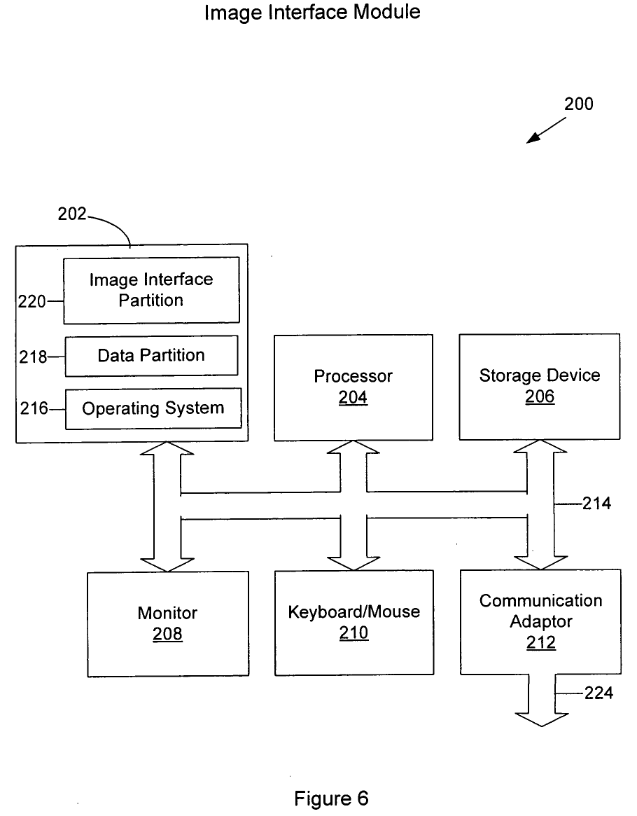

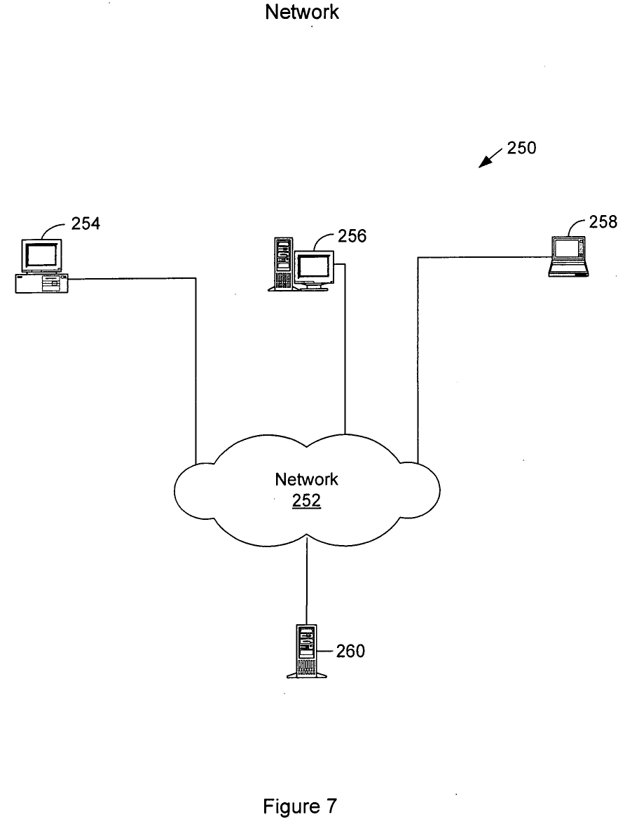

A virtual microscope slide or virtual slide may include digital data representing an image or magnified image of a microscope slide, and may be a digital slide or image of a slide. Where the virtual slide is in digital form, it may be stored on a medium, such as in a computer memory or storage device, and may be transmitted over a communication network, such as the Internet, an intranet, a network described with respect to FIG. 6 and FIG. 7, etc., to a viewer at a remote location, such as one of nodes 254, 256, 258, or 260 described with respect to FIG. 7 and which may be, for example, an image interface 200 or digital microscopy station 901 as described herein.

Virtual slides may offer advantages over traditional microscope slides in certain instances. In some cases, a virtual slide may enable a physician to render a diagnosis more quickly, conveniently, and economically than is possible using a traditional microscope slide. For example, a virtual slide may be made available to a remote user, such as over a communication network to a specialist in a remote location, enabling the physician to consult with the specialist and provide a diagnosis without delay. Alternatively, the virtual slide may be stored in digital form indefinitely for later viewing at the convenience of the physician or specialist.

A virtual slide may be generated by positioning a microscope slide (which may contain a specimen for which a magnified image is desired) under a microscope objective, capturing one or more images covering all or a portion of the slide, and then combining the images to create a single, integrated, digital image of the slide. It may be desirable to partition a slide into multiple regions or portions and to generate a separate image for each region or portion, since the entire slide may be larger than the field of view of a magnifying (20×, for example) objective lens of an imager. Additionally, the surfaces of many tissues may be uneven and contain local variations that create difficulty in capturing an in-focus image of an entire slide using a fixed z-position. As used herein, the term “z-position” refers to the coordinate value of the z-axis of a Cartesian coordinate system. The z-axis may refer to an axis in which the objective lens is directed toward the stage. The z-axis may be at a 90° angle from each of the x and y axes, or another angle if desired. The x and y axes may lie in the plane in which the microscope stage resides. Accordingly, some techniques may include obtaining multiple images representing various regions or portions of a slide, and combining the images into an integrated image of the entire slide.

One technique for capturing digital images of a microscopic slide is the start/stop acquisition method. According to this technique, multiple target points on a slide may be designated for examination. An objective lens (20×, for example) may be positioned over the slide. At each target point, the z-position may be varied and images may be captured from multiple z-positions. The images may then be examined to determine a desired-focus position. If one of the images obtained during the focusing operation is determined to be sufficiently in-focus, that image may be selected as the desired-focus image for the respective target point on the slide. If none of the images is in-focus, the images may be analyzed to determine a desired-focus position. The objective may be moved to the desired-focus position, and a new image may be captured. In some cases, a first sequence of images may not provide sufficient information to determine a desired-focus position. In such a case, a second sequence of images within a narrowed range of z-positions may be captured to facilitate determination of the desired-focus position. The multiple desired-focus images (one for each target point) obtained in this manner may be combined to create a virtual slide.

Another approach used to generate in-focus images for developing a virtual slide includes examining the microscope slide to generate a focal map, which may be an estimated focus surface created by focusing an objective lens on a limited number of points on the slide. Then, a scanning operation may be performed based on the focal map. Some techniques or systems may construct focal maps by determining desired-focus information for a limited number of points on a slide. For example, such techniques or systems may select from 3 to 20 target points on a slide and use an objective lens to perform a focus operation at each target point to determine a desired-focus position. The information obtained for those target points may then be used to estimate desired-focus information for any unexamined points on the slide.

Start/stop acquisition systems, as described above, may be relatively slow because the microscope objective may often be required to perform multiple focus-capture operations for each designated target point on the microscopic slide. In addition, the field-of-view of an objective lens may be limited. The number of points for which desired-focus information is directly obtained may be a relatively small portion of the entire slide.

Techniques for constructing focal maps may also lack some advantages of other techniques in certain cases. First, the use of a high-power objective to obtain desired-focus data for a given target point may be relatively slow. Second, generating a focal map from a limited number of points on the slide may create inaccuracies in the resulting focal map. For example, tissue on a slide may often not have a uniform, smooth surface. Also, many tissue surfaces may contain variations that vary across small distances. If a point on the surface of the tissue that has a defect or a significant local variation is selected as a target point for obtaining focus information, the deviation may affect estimated values for desired-focus positions throughout the entire focal map.

Regardless of focus technique, users may continue to demand higher and higher speeds while desiring increased quality. Numerous systems may attempt to meet user demand by utilizing a region of interest detection routine as part of the image acquisition procedure. Rather than scan or otherwise image the entire slide, these systems may attempt to determine what portions of the slide contain a specimen or target tissue. Then only the area of the slide containing the specimen or target tissue may be scanned or otherwise imaged. Since most of the slide may not contain a specimen, this imaging technique may result in a significant reduction in overall scan time. While conceptually simple, in practice this technique may be hampered by many artifacts that exist in slides. These artifacts may include dirt, scratches, slide bubbles, slide coverslip edges, and stray tissue fragments. Since there may be tremendous variability with these artifacts in certain cases, such region of interest detection routines may be required to include one or more sophisticated image scene interpretation algorithms. Given a requirement that all tissue may have to be scanned or otherwise imaged, creating such an algorithm may be very challenging and may be, in some cases, unlikely to succeed 100% in practice without significant per user customization. Another option may be to make the sensitivity of the system very high, but the specificity low. This option may result in a greater likelihood the tissue will be detected because of the sensitivity, but also in the detection of artifacts because of the low specificity. That option may also effectively reduce scan or other imaging throughput and correspondingly benefit the region of interest detection.

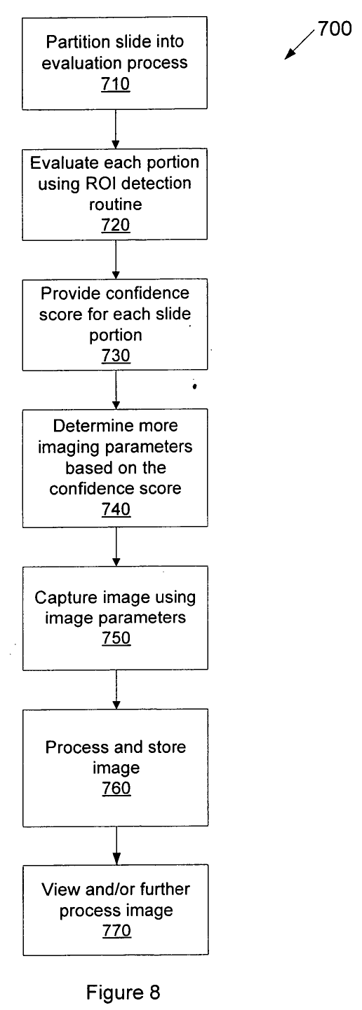

In one embodiment, the capturing of an image, at 110 of FIG. 1, employs an image creation method 700 as in FIG. 8. The image creation method 700 may incorporate one or more components. First may be a routine, which may be, for example, a set of instructions, such as in a software or other program, that may be executed by a computer processor to perform a function. The routine may be a multitiered region of interest (ROI) detection routine. An ROI detection routine may include a system or method for locating ROIs on a slide, such as regions including tissue, for imaging, such as described, for example, in U.S. patent application Ser. No. 09/919,452 or 09/758,037. The ROI detection routine may locate the ROIs by analyzing a captured image of the slide, such as a macro image of the entire slide or an image of a slide portion. Rather than provide a binary determination as to where tissue is and is not located on a slide, the image creation method 700 may, with an ROI detection routine that is a multitiered ROI detection routine, evaluate portions of the slide by grading the captured images of the various portions, such as with a confidence score, according to their probability of including an ROI.

A multitiered ROI routine may, for example, perform such grading by thresholding certain statistical quantities, such as mean and standard deviation of pixel intensity or other texture filter output of a slide image portion to determine whether the corresponding slide portion contains tissue or nontissue. A first threshold that may be expected to include tissue may be applied to one of the first metrics, such as mean. For each pixel in the image, a mean of the surrounding pixels in, for example, a 1 mm×1 mm area, may be computed. If the mean for a given area is in the threshold range of 50-200 (in the case of an 8 bit (0-255) grey scale value), for example, then the portion of the slide to which that pixel corresponds, and thus the pixel, may be considered to include tissue. If the mean is less than 50 or greater than 200 then it may be considered not to show or otherwise include tissue. A second thresholding step may be configured to be applied to the standard deviation. Similar to the computation for mean, each pixel may have a standard deviation for it and its surrounding pixels (e.g. 1 mm×1 mm area) computed. If the standard deviation is greater than a certain threshold, say 5, then that pixel may be considered to show tissue. If it is less than or equal to the threshold then it may not be considered to show tissue. For each pixel position, the results of the first and second thresholding steps may be compared. If for a given pixel position, neither of the threshold operations indicate that the pixel shows tissue, then the pixel may be assigned as non-tissue. If only one of the thresholds indicates that the pixel shows tissue, the pixel may be given a medium probability of showing tissue. If both indicate that the pixel shows tissue, then both may be considered to show tissue.

Alternatively, in one embodiment, the single threshold can be maintained and an enhancement applied at the tiling matrix phase, or phase in which the slide image is partitioned into tiles or pixels or other portions. The number of pixels marked as showing tissue as a percentage of total pixels in the tiling matrix may be used as a confidence score. A tile with a large amount of positive pixels, or pixels marked as showing tissue, may be highly likely to show tissue, whereas a tile with a very low amount of positive pixels may be unlikely to actually show tissue. Such a methodology may result in a more continuous array of scores (e.g., from 0 to 100), and may thus allow for a more continuous array of quality designations for which each pixel or other portion is to have an image created.

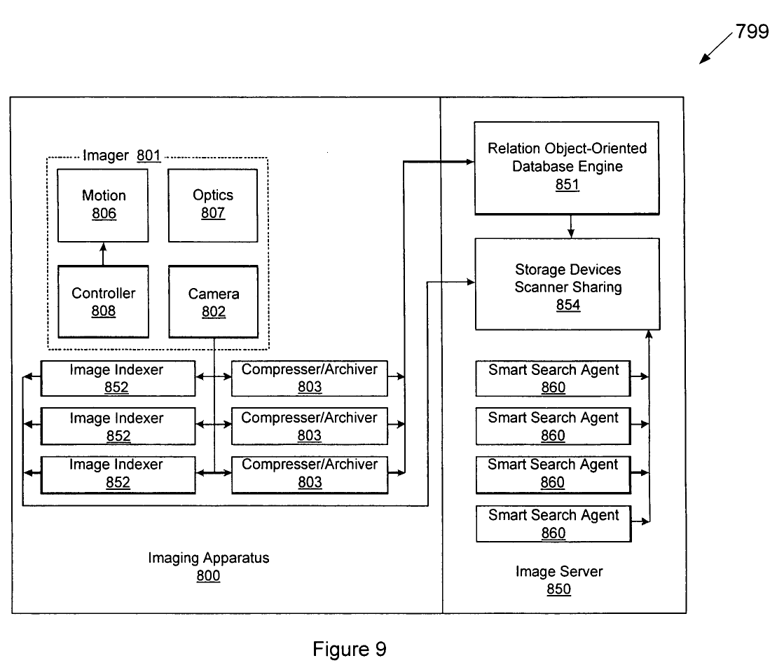

The image creation method 700 may, at 710, identify one or more slide portions to be evaluated. Thus, the image creation method 700 may, at 710, initially segment the slide image into evaluation portions, such as by partitioning the slide image, in an embodiment, into a uniform grid. An example would be partitioning a 50 mm×25 mm area of a slide into a 50 by 25 grid that has 1250 portions that are blocks, each defining an approximately 1 mm² block. In one embodiment, the image creation method 700 at 710 includes first capturing an image of at least the slide portions to be identified for evaluation, such as with the imager 801 of FIG. 9 or otherwise as described herein, for example.

Each block may, at 720, be evaluated. Each block in the example may, at 730, be given a confidence score that corresponds to the probability of the area of that block containing tissue. The confidence score, or ROI probability or likelihood, may determine or correspond with, or otherwise influence, the quality, as determined at 740 and discussed below, with which an image of the block or other portion is to be acquired, at 750, by the imaging apparatus, such as the imaging apparatus 800 embodiment of FIG. 9. Quality of an image may be dependent upon one or more imaging parameters, such as resolution, stage speed, scan or other imaging settings, bit or color depth, image correction processes, and/or image stitching processes. In one embodiment, the multitiered ROI detection routine may include 720, 730, and possibly also 740 In another embodiment, the multitiered ROI detection routine may also include the partitioning of the slide, at 710, into evaluation portions.

In one embodiment, resolution of the slide image or specimen image is the most directly relevant metric of image quality. The resolution of an image created by an imager, such as the imager 801 of FIG. 9 as described herein, may refer to the sharpness and clarity of the image, and may be a function of one or more of the criteria of the imager, including digital resolution, resolving power of the optics, and other factors. Digital resolution refers to the maximum number of dots per area of a captured digital image. Portions of an image with the highest probabilities of having tissue may, at 750, be scanned or otherwise imaged at the highest resolution available, which may correspond to the highest quality in some circumstances. Portions with the lowest probability of having tissue and thus the lowest confidence scores may, at 750, be imaged at the lowest quality, which may correspond to the lowest image resolution available. The confidence score may be directly correlated to imaging resolution, and/or one or more other forms of image quality or other desired imaging parameters, such as described herein.

In an embodiment where an image of the portion or portions having the lowest quality has already been captured, such as at 710 for purposes of evaluation by the multitiered ROI detection routine, the already captured image may be used, and the portion or portions may not be reimaged, such as described with respect to image redundancy below.

Depending on the capabilities of an image system according to one embodiment, one or more intermediate resolutions that correspond to intermediate probabilities of tissue, and thus to intermediate confidence scores, may be determined at 740 and imaged at 750. If the imager or imaging apparatus has discrete resolutions, the number of intermediate resolutions may fundamentally be discrete. For example, with 5 objective magnifications available (2×, 4×, 10×, 20×, 40×), the system may define the lowest resolution imaging as being done with a 2× objective, the highest resolution with a 40× objective, and three intermediate resolutions with 4×, 10×, and 20× objectives.

In an embodiment with discrete resolution choices, the probability of a slide portion containing tissue, and thus the confidence score determined at 730, may be binned into one of the resolutions for purposes of defining, at 740, an imaging resolution setting for that portion. For example, the image creation method 700 may include binning the slide portion, such as at 740, by storing its location on the slide along with the resolution in which that slide portion is to be imaged.

The determination of the bin may be done, at 740, by any of various methods including, for example, thresholding and adaptive thresholding. In an example of simple thresholding in the case of three discrete resolution options, two thresholds may be defined. The first threshold may be a 10% confidence score and the second threshold may be a 20% confidence score. That is, confidence scores less than 10% may be categorized in the lowest resolution bin. Confidence scores less than 20% but greater than or equal to 10% may be in the medium resolution bin. Confidence scores greater than or equal to 20% may be in the highest resolution bin.

In an example of adaptive thresholding, the highest and lowest probability scores, and thus the highest and lowest confidence scores for the grid portions of a particular specimen, may be computed. A predefined percentage of the difference between the highest and lowest confidence scores may be added to the lowest confidence score to determine a low resolution threshold confidence score. Confidence scores for portions falling between the low confidence score and the low threshold may be categorized in the lowest resolution bin. A different (higher) percentage difference between the highest and lowest confidence scores may be added to the lowest confidence score to determine the next, higher resolution threshold and so on for all the different resolutions. The various percentage difference choices may be determined as a function of various parameters, which may include, for example, the number of objectives available to the system, their respective image resolving powers, and/or the best available resolution at the top of the range.

In one embodiment, an example of the image creation method 700 may include, at 720, 730, and 740, analyzing a slide or other sample and determining that it has, among its evaluation portions, a lowest confidence score of 5 and a highest confidence score of 80. These scores may correspond to probability percentages regarding whether the portions are ROIs, or may correspond to other values. The image creation method 700 may be employed with an imager, such as the imager 801 as described herein, that may have three discrete resolution options—2 microns per pixel resolution, 0.5 micron per pixel resolution, and 0.25 micron per pixel resolution, for example. A first threshold may be defined as the lowest value plus 10% between the difference of the highest and lowest values, or 5+((80−5)*0.1)=12.5. A second threshold may be defined as the lowest value plus 20% between the difference of the highest and lowest values 5+((80−5)*0.2)=20. Portions with confidence scores less than the first threshold may be imaged at 2 microns per pixel. Portions and with confidence scores equal to or above the first threshold but less than the second threshold may be imaged at 0.5 microns per pixel. Regions with confidences scores equal to or above the second threshold may be imaged at 0.25 microns per pixel.

In another embodiment, discrete resolution choices may, at 740, be turned into a more continuous set of quality choices by adding other image acquisition parameters that affect image quality to the resolution algorithm. In the case of a continuous scanning or other imaging apparatus, stage speed may be one of the image acquisition parameters that may have a significant effect on image quality. Higher stage speeds may often provide higher image capture technique speeds, but with corresponding lower image resolution, and thus quality. These properties associated with imaging at higher stage speeds may be employed in combination with multiple objectives. A nominal image resolution may be associated with a nominal imaging speed which, for example, may be in the middle of the speed range. Each objective may be associated with multiple imaging speed settings, both faster and slower than the nominal imaging speed, such that changes in imaging speed changes from the nominal imaging speed for that objective lens may be used to increase or decrease the resolution of an image captured with that objective. This technique of varying stage speed during imaging may allow the number of quality bins to be expanded beyond the number of objectives, such as by including bins associated with each objective and additional or sub-bins for two or more stage speeds associated with one or more of those objectives.

For example, there may be two main bins designated for portions to be imaged with 10× and 20× scanning objectives, respectively. These two main bins may be subdivided into two smaller bins: 10× objective, stage speed 50 mm/sec; 10× objective, stage speed 100 mm/sec; 20× objective, stage speed 25 mm/sec; and 20× objective, stage speed 50 mm/sec.

In another embodiment, a multiplane acquisition method, the number of focal planes in which images are to be captured, at 750, may be a variable that affects quality and speed of image capture. Therefore, the number of focal planes, or focal distances, may also be used to provide, at 740, additional quality bins. In the case of systems that employ multiple focal planes to improve focus quality through plane combination (e.g., the imaging of a slide at various z-positions), more planes may correspond to a higher probability of the highest possible resolution being available for the objective for imaging. As a consequence, the number of focal planes captured may be used to provide, at 740, more resolution bins or quality bins for an objective. The lowest quality bin for an objective may have one focal plane, whereas the highest quality bin may have 7 focal planes, for example. Each objective may have its own unique bin definitions. For example, a 2× objective may have only one bin with one focal plane whereas a 10× objective may have three bins—the lowest quality with one focal plane, another quality with two focal planes, and the highest quality with three focal planes. The number of quality bins appropriate for a given imaging objective may be user definable, but may be proportional to the numerical aperture (NA) of the objective, with higher NA objectives having more focal planes. For example, a high NA objective of 0.95 may have 10 focal planes whereas a lower NA objective of 0.5 may have 3 focal planes.

The resulting imaging data may produce image data for the entire desired area of the slide. However, each portion of the acquired image area may have been captured, at 750, at different quality settings. The system may inherently provide for the ability to eliminate redundancies in imaged areas. For example, the system may, by default, not image, at 750, the same area with more than one quality setting, which may increase the efficiency of the system. For example, if data to be used to capture an image, such as a tiling matrix having portions that are tiles (e.g. square or other shaped portions), indicates that a portion of an image is to be acquired at more than one quality level, then that portion may be imaged at the highest quality level indicated.

Image quality may be dependent on various imaging parameters, including, for example, the optical resolution of the objective lens and other aspects of the optics, the digital resolution of the camera or device capturing the image and other aspects of the image capturing device such as bit-depth capturing ability and image compression level and format (e.g. lossless, lossy), the motion of the specimen in relation to the optics and image capturing device, strobe light speed if applicable, the accuracy with which the optics and image capturing device are focused on the specimen being imaged, and the number of possible settings for any of these imaging parameters.

Focus quality, and thus image quality, may furthermore be dependent on various focus parameters, including, for example, number of focal planes, and focus controls such as those described in U.S. patent application Ser. No. 09/919,452.

Other parameters that may affect image quality include, for example, applied image correction techniques, image stitching techniques, and whether the numerical aperture of the optics is dynamically-adjustable during imaging.

Alternative configurations and embodiments of an image creation method 700 may provide for imaging redundancy. Image redundancy may be a useful mechanism to determine focus quality of an imaged area. For example, a lower quality but higher depth of field objective, such as a 4× objective, may be employed to image a given area. A higher quality but narrower depth of field, such as a 20× objective, may be employed to image that same area. One may determine the focus quality of the 20× image by comparing the contrast range in the pixel intensities in the 20× image with that of the 4× image. If the 20× image has lower contrast than the 4× image, it may be that the 20× image is out of focus. The technique may be further refined by analyzing the corresponding images obtained from the 4× and 20× objectives in a Fourier space along with the respective OTF (Optical Transfer Function) for the objectives. The Fourier transform of the 4× image is the product of the OTF of the 4× objective and the Fourier transform of the target. The same may hold for the 20× objective. When both images are in focus, the target may be identical. Therefore, the product of the 4× OFT and the 20× Fourier image may equal the product of the 20× OFT and the 4× Fourier image. As the 4× image may be mostly likely to be in focus, large deviations from the above equation may mean that the 20× image is out of focus. By taking absolute values on both sides of the equation, the MTF (Modulation Transfer Function) may be used instead of the OTF, as it may be more readily available and easier to measure.

The OTF and MTF may either be obtained from lens manufacturers or measured by independent labs. In practice, an estimated OTF or MFT may be used for the type of the objective, rather than obtaining OTF/MTF for each individual objective.

Other practical considerations may including minimizing the contribution of system noise by limiting the range of frequencies in the comparison. Configuration may be needed to determine the most effective range of frequencies for the comparison and what constitutes a large deviation in the equation. Configuration may also be need for different target thickness. In an embodiment, image redundancy may be achieved through multiple binning steps. A given grid block or other portion of a slide may be put into a second bin by application of a second binning step with one or more rules. For example, in addition to the binning that may be part of 740 as described above, a second rule may be applied at 740. An example of a second rule is a rule that puts all blocks or other portions of the specimen in the lowest resolution or quality bin in addition to the bin that they were put into during the first binning step. If the first binning step resulted in that block or other portion being put into the lowest resolution or quality bin, then no additional step may occur with respect to that block or other portion, since that block or other portion was already in that bin.

If an original image that was utilized to determine the ROIs is of adequate quality, it may be utilized as a data source. The original image may serve as a redundant image source or it may be utilized to provide image data to one of the bins. For example, if the image for determining ROIs was made using a 2× objective, this image may be utilized to provide image data for the 2× bin. This may afford efficiency, since data already captured could be used as one of the redundant images.

In one embodiment, the determination of the area to be imaged may be specified by the user before imaging. Additional parameters such as, for example, imager objective, stage speed, and/or other quality factors may also be user adjustable. Focus point or area selection may be manual or automated. In the case of manual focus point or area selection, the user may mark areas on a slide to capture focus points or areas from which to create a focus map. In the case of an automated system for focus point or area detection, an automated ROI detection routine is applied but it serves to provide focus points for a focus map rather than define the imaging area. The focus map may be created as described in pending U.S. patent application Ser. No. 09/919,452, for example.

FIG. 9 illustrates an image system 799, in accordance with an embodiment. Images that are acquired may be compressed such as shown in and described with respect to the compressor/archiver 803 of the image system 799 of FIG. 9, and stored on a permanent medium, such as a hard disk drive and/or a storage device 854 of an image server 850, such as described herein with respect to FIG. 9. Many formats may be employed for compressing and storing images. Examples of such formats include JPEG in TIFF, JPEG2000, GeoTIFF, and JPEG2000 in TIFF. Any given area may have a corresponding set of imaged data, which may be stored in a file. If there is more than one image available for a given imaging area, both may be stored. Multi area storage may be accomplished by a process that includes creating multiple image directories in each file, with each directory representing one image.

Returning to FIG. 8, when an image is going to be used, at 760, by, for example, a human for viewing purposes at a view station such as an image interface 200 or digital microscopy station 901 described herein, or for computer based analytical purposes, one or more additional rules may be employed for extracting and rendering image data. An image request, at 760, may comprise a request for an image of an area of a slide to be displayed as well as a zoom percentage or resolution associated therewith. If image data at the requested zoom percentage or resolution level for the area requested does not exist for all or a portion of the requested image data, then the system, according to one embodiment, may employ sampling techniques that serve to resample (upsample or downsample) the necessary portion of the image to the requested zoom specification.

For example, if the user requested an image, at 760, for a given area defined by rectangle ‘A’ with a zoom percentage of 100%, but the system had data available for only one half the image at 100% zoom and the other half only at 50%, the system may upsample the 50% image to create an image equivalent in zoom percentage to 100%. The upsampled data may be combined with the true 100% image data to create an image for the area defined by rectangle A at 100%. This upsampling may occur before transmission or after transmission to a client such as nodes 254, 256, and 258 in FIG. 7, from a server 260. Upsampling after transmission may provide efficiency in minimizing size of data transmitted. As an embodiment of this invention may create images at multiple qualities, some regions may be likely to have all desired data at the requested quality, while other regions may have only part of the area available at the requested quality and may therefore have to resample at 750 using altered imaging parameters. Other regions may not have any of the requested qualities available and may have to resample for the entire area.

Triggered z capture may include, for example, capturing, such as at 710 or 750, one or more images of all or part of a target when the optics of the imager, such as the imager 801 embodiment of FIG. 9, are positioned at one or more desired focal lengths. The imager 801 may capture those images based on a commanded optic position or as sensed by a position sensor.

One embodiment includes a method for capturing multiple focal planes rapidly. The z axis control system on a microscope used in the system, such as the microscope optics 807 of the imager 801 as in FIG. 9, may be set in motion along a predetermined path. During this motion, an encoder or similar device to indicate z-position may send position data to a controller device. At predetermined positions, the controller may fire a trigger pulse to a camera, such as the camera 802 of the imager 801, strobe light, or other device in order to effectuate capture of an image at a specified z-position. Capture of multiple images along with corresponding z-position data for each image may provide a multifocal plane data set as well as providing data to calculate a z-position of optimum or desired focus. This optimum or desired focus calculation may be performed by various methods, such as by a method employing a focal index based upon entropy.

An alternative embodiment to triggering the exposure of the camera is to run the camera in a free run mode where the camera captures images at a predetermined time interval. The z position for each image grabbed can be read from the z encoder during this process. This provides a similar z stack of images with precise z positions for each image. Utilization of such a free run mode may be advantageous because it may give access to a wider range of cameras and be electronically simpler than triggered exposure.

In an embodiment, the quality of a slide image may be dependent upon both the quality of the captured image and any post-image capture processing that may change the quality.

In an embodiment, the post processing of captured images of variable resolution may include selecting images or portions thereof based upon image quality, which may depend, at least in part, on focus quality. In an embodiment, the post processing may include weighting image portions corresponding to adjacent portions of the imaged slide. Such weighting may avoid large variations of focal planes or other focal distances in which adjacent slide portions were imaged, and may thus avoid the appearance of a separating line and/or other discontinuity in the corresponding image portions when assembled together. Such weighting may also avoid an appearance of distortion and/or other undesirable properties in the images.

For example, in an embodiment where an image is captured in square or rectangular portions, a selected portion may have eight adjacent portions when the digital image is assembled. The selected portion and the adjacent portions may furthermore be captured at ten focal lengths. If the best focal length for the selected portion is the sixth focal length and the best focal lengths for the adjacent tiles vary from the eighth to the ninth focal lengths, then the seventh focal length may be used for selected portion to limit the variance of its focal length relative to those of the adjacent portion, so as to avoid undesirable properties such as described above.

In another embodiment, slide images that were captured, at 750, at one or more resolution(s) are modified, at 760, so as to comprise a new variable quality slide image. The modification may include designating quality settings for given areas, which may each include one or more portions in one embodiment, of the slide image. While viewing a slide, the user may be able to designate numerous portions or areas of the slide image for resaving at a new quality setting. This area designation may be by freehand drawing of a closed area, or by a rectangle, a circle, or other area designation. The user may modify multiple quality properties for each area, including resolution, compression level, and number of focal planes (in the case of a multifocal plane scan). The user may also designate an area for a complete whiteout or blackout that may include completely eliminating data from that area of the slide in order to achieve a higher or the highest possible compression. Additional compression may also be achieved by referencing another white or black block or other area instead of storing the white or black block or other area.

The user may also crop the slide image in order to make the slide image smaller in size. The combination of cropping and user selected area reprocessing, such as described above, may be applied to the slide image data, and a new slide may be assembled. The new slide may have the same name as the previous slide or a different name. For file formats that support rewrite, it may be possible to modify the original slide without creating a completely new slide. Such a mechanism may be more time efficient, particularly for slide images that do not have significant areas of change.

These post processing methods may be employed in an automated QC System such as described herein, for example.

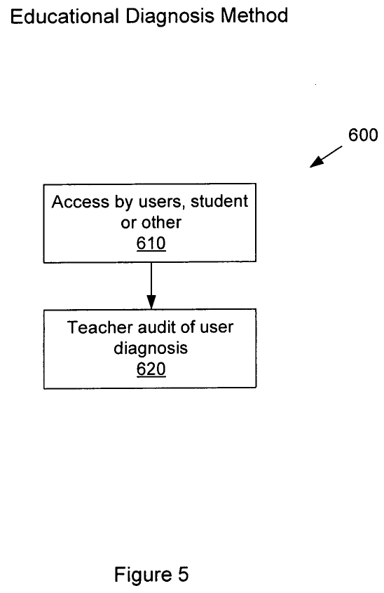

Annotations associated with images may be added at 760, such as for storing on or in association with the images on a server, such as the image server 850 described herein, and may have multiple fields associated with them, such as user and geometric descriptions of the annotation. Adding a z-position to the annotation may provide further spatial qualification of the annotation. Such qualification may be particularly useful in educational settings, such as where the education system 600 of FIG. 5 is employed, where an instructor wants to call attention to a feature lying at a particular x, y, z position.

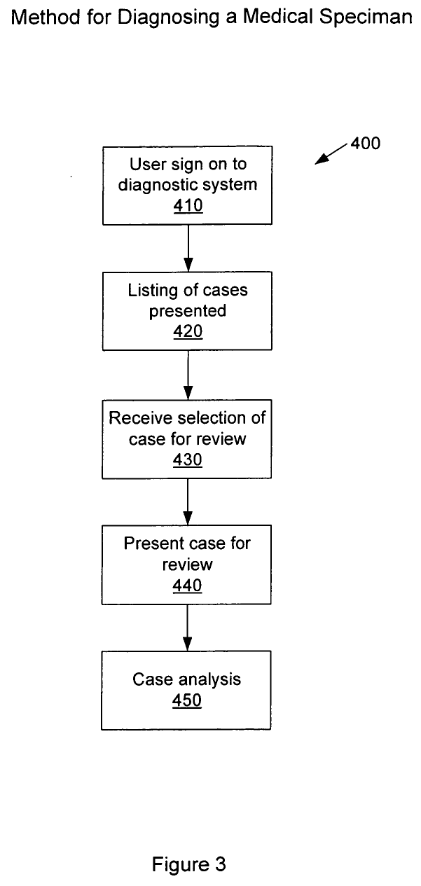

In one embodiment, the adding of annotations may be done by use of the diagnostic system 400 embodiment of FIG. 3, such as described herein.

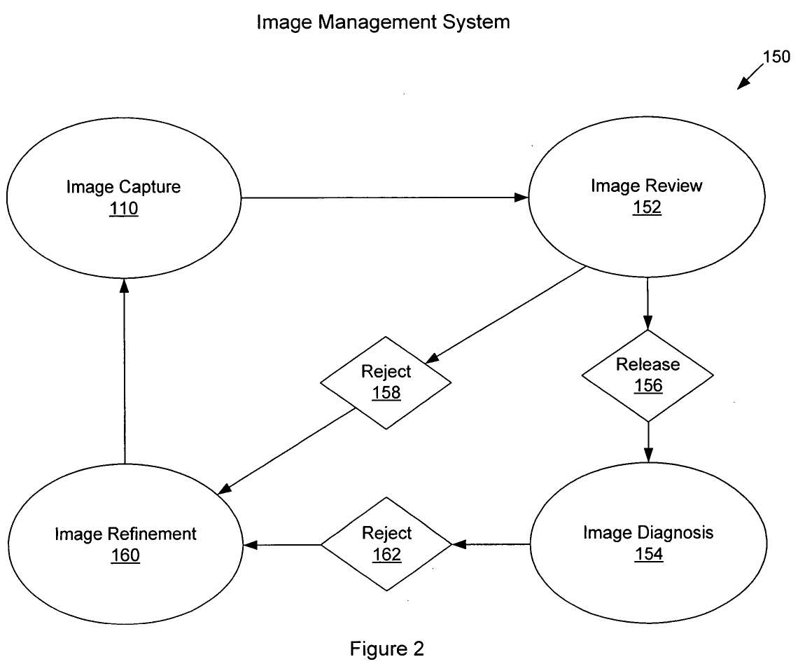

FIG. 2 illustrates an embodiment of an image management system 150 that may be utilized to permit bulk approval of images after imaging has been completed. At 110, an image of a specimen is captured. The image may be reviewed, at 152, by a specimen review system or a technician, for example, to confirm that the image is appropriate for review or amenable to diagnosis 154 by a diagnoser such as a diagnostic system, a physician, a pathologist, a toxicologist, a histologist, a technician or another diagnostician. If the image is appropriate for review, then the image may be released to the diagnostic system or diagnostician at 156. If the image is not appropriate for review, then the image may be rejected at 158. A rejected image may be reviewed by an image refiner 160 such as an image refining system or an image specialist technician. New imaging parameters may be determined for the specimen, such as by way of the image creation method 700 described with respect to the embodiment of FIG. 8, and a new image of the specimen may be captured by the image capture system 110. The diagnostic system or diagnostician may also reject images at 162 and those rejected images may be reviewed by the image refining system or image specialist technician 160 and a new image may be captured under new conditions by the image capture system 110.

Image review 152 may involve a computerized system or a person determining, for example, whether a new specimen is likely required to achieve a diagnosis or whether the existing specimen may be re-imaged to attain an image that is useful in performing a diagnosis. A new specimen may be required, for example, when the specimen has not been appropriately stained or when the stain was improperly applied or overly applied making the specimen too dark for diagnosis. One of many other reasons an image may be rejected such that a new specimen should be mounted is damage to the imaged specimen such that diagnosis may not be made from that specimen. Alternately, an image may be rejected for a reason that may be corrected by re-imaging the existing specimen.

When an image is rejected at 158, the image may be directed to the image refining system or the image specialist technician 160. Where it appears possible to improve the image by recapturing an image from the existing specimen, the image refining system or image specialist technician may consider the image and determine a likely reason the image failed to be useful in diagnosis. Various imaging parameters may be varied by the image refining system or image specialist technician to correct for a poor image taken from a useable specimen. For example, a dark image may be brightened by increasing the light level applied to the specimen during imaging and the contrast in a washed out image may be increased by reducing the lighting level applied to the specimen during imaging. A specimen or portion of a specimen that is not ideally focused may be recaptured using a different focal length, and a tissue that is not completely imaged may be recaptured by specifying the location of that tissue on a slide and then re-imaging that slide, for example. Any other parameter that may be set on an imager may similarly be adjusted by the image refining system or the image specialist technician.

Similarly, the diagnostician 154 may reject one or more images that were released at 156 by the image refining system or the image specialist technician 160 if the diagnostician 154 determines that refined images are desirable. Images may be rejected by the diagnostician 154 for reasons similar to the reasons the image refining system or the image specialist technician 160 would have rejected images. The rejected images may be directed to the image refining system or the image specialist technician 160 for image recapture where such recapture appears likely to realize an improved image.

In an embodiment, the image review 152 and image rejection 158 may include one or more parts of the image creation method 700 embodiment of FIG. 8, either alone or in conjunction with review by a person, such as a diagnoser or an image specialist technician.

Referring again to FIGS. 1 and 2, case management may be incorporated into image review 152 or elsewhere, to organize images and related text and information into cases. Case management can be applied after all desired images have been captured and related information has been collected and case management can also be applied prior to collecting images and related text by, for example, informing a user of how many and what types of images and related text are expected for a case. Case management can inform a user of the status of a case or warn a user of missing information.

When a tissue specimen is removed or harvested 102, it is often separated into numerous specimens and those specimens are often placed on more than one slide. Accordingly, in an embodiment of case management, multiple images from multiple slides may, together, make up a single case for a single patient or organism. Additionally, a Laboratory Information System (“LIS”), Laboratory Information Management System (“LIMS”), or alternative database that contains relevant case information such as, for example, a type of specimen displayed, a procedure performed to acquire the specimen, an organ from which the specimen originated, or a stain applied to the specimen, may be included in or may communicate with the image management system 150 such that information may be passed from the LIS or LIMS to the image management system and information may be passed from the image management system to the LIS or LIMS. The LIS or LIMS may include various types of information, such as results from tests performed on the specimen, text inputted at the time of grossing 104, diagnostic tools such as images discovered in the same organ harvested from other patients having the disease suspected in the case and text that indicates conditions that are common to the disease suspected in the case, which may be associated with the case as desired. Thus, during image review 152, all images and related information for each case may be related to that case in a database. Such case organization may assist in image diagnosis by associating all information desired by diagnostic system or diagnostician so that the diagnostic system or diagnostician can access that information efficiently.

In one embodiment of a case management method, which may be implemented in a computerized system, a bar code, RFID, Infoglyph, one or more characters, or another computer readable identifier is placed on each slide, identifying the case to which the slide belongs. Those areas on the slide with the identifier, typically called the ‘label area,’ may then be imaged with the slides or otherwise read and associated with the slides imaged to identify the case to which the slide belongs. Alternately, a technician or other human may identify each slide with a case.

In an embodiment, imaging parameters may be set manually at the time the image is to be captured, or the parameters may be set and associated with a particular slide and retrieved from a database when the image is to be captured. For example, imaging parameters may be associated with a slide by a position in which the slide is stored or placed in a tray of slides. Alternately, the imaging parameters may be associated with a particular slide by way of the bar code or other computer readable identifier placed on the slide. The imaging parameters may be determined, in an embodiment, at least in part by way of the image creation method 700 of FIG. 8 as described herein.

In one embodiment, an imager checks for special parameter settings associated with an image to be captured, utilizes any such special parameter settings and utilizes default parameters where no special parameters are associated with the image to be captured. Examples of such imaging parameters include resolution, number of focal planes, compression method, file format, and color model, for example. Additional information may be retrieved from the LIS, LIMS, or one or more other information systems. This additional information may include, for example, type of stain, coverslip, and/or fixation methods. This additional information may be utilized by the image system to derive imaging parameters such as, for example, number of focus settings (e.g., number of points on which to focus, type of curve to fit to points, number of planes to capture), region of interest detection parameters (e.g., threshold, preprocessing methods), spectral imaging settings, resolution, compression method, and file format. These imaging parameters may be derived from the internal memory of the scanner itself or another information database. Then, as the slides are picked and placed on the imaging apparatus, the appropriate imaging parameters may be recalled and applied to the image being captured.

Information retrieved about the slide from the LIS, LIMS or other information system may also be utilized by an automated Quality Control (“QC”) system that operates during or after slide imaging. The automated QC system may check to see that the stain specified in the LIS or LIMS is the actual stain on the slide. For example, the LIS may specify that the stain for that slide should be H+E, analysis may reveal that the stain is Trichrome. Additionally, the LIS may specify the type of tissue and/or the number of tissues that should be on the slide. A tissue segmentation and object identification algorithm may be utilized to determine the number of tissues on the slide, while texture analysis or statistical pattern recognition may be utilized to determine type of tissue.

The automated QC system may also search for technical defects in the slide such as weak staining, folds, tears, or drag through as well as imaging related defects such as poor focus, seaming defects, intrafield focus variation, or color defects. Information about type and location of detected defects may be saved such that the technician can quickly view the suspected defects as part of the slide review process done by the technician or image specialist technician. A defect value may then be applied to each defect discovered. That defect value may reflect the degree the defect is expected to impact the image, the expected impact the defect will have on the ability to create a diagnosis from the image, or another quantification of the effect of the defect. The system may automatically sort the imaged slides by order of total defects. Total defects may be represented by a score that corresponds to all the defects in the slide. This score may be the sum of values applied to each defect, the normalized sum of each defect value, or the square root of the sum of squares for each value. While a defect score may be presented, the user may also view values for individual defects for each slide and sort the order of displayed slides based upon any one of the individual defects as well as the total defect value. For example, the user may select the focus as the defect of interest and sort slides in order of the highest focus defects to the lowest. The user may also apply filters such that slides containing a range of defect values are specially pointed out to the user.

The automated QC system may also invoke an automated rescan process. The user may specify that a range of defect values requires automatic rescanning (note that this range of defect values may be a different range than that used for sorting the display previously mentioned.) A slide with a focus quality of less than 95% of optimal, for example, may automatically be reimaged.

The slide may be reimaged with different scan or other imaging settings. The different imaging settings may be predetermined or may be dynamically determined depending on the nature of the defect. An example of reimaging with a predetermined imaging setting change is to reimage the slide with multiple focal planes regardless of the nature of the defect. Examples of reimaging with a dynamically determined imaging setting are to reimage using multiple focal planes if focus was poor, and to reimage with a wider search area for image alignment in the case of seaming defects.

Alternately or in addition, where the diagnoser determines that a diagnosis is not possible from the image, a slide may be loaded into a microscope and reviewed directly by the diagnoser. Where the diagnoser is at a location remote from the slide and microscope, the diagnoser may employ a remote microscope control system to perform a diagnosis from the slide.

FIG. 3 is a flow chart of an embodiment of a method that may be utilized in a computerized system for diagnosing medical samples or other specimens 400, such as human or animal tissue or blood samples. The diagnostic system 400 may include, and the method may employ, a computerized database system, wherein information in the database is accessible and viewable by way of an imaging interface computer application with a user interface, such as a graphical user interface (“GUI”). In an embodiment, the computer application may operate over a network and/or the Internet. In one embodiment, once one or a group of images of specimens has been accepted for review, a user such as a histologist or other researcher may access images of the specimens through the diagnostic system 400. In one embodiment a user, at 410, signs on or otherwise accesses the diagnostic system 400. The diagnostic system 400 may require that a user provide a user identification and/or a password to sign on.

Once the user has signed on, the system may, at 420, present a listing of cases to which the user is contributing and/or with which the user is associated. Additionally, the user may be able at 420 to access cases to which he or she has not contributed and/or is not associated. The diagnostic system 400 may facilitate finding such other cases by employing a search bar and/or an index in which cases are categorized by name, area of medicine, disease, type of specimen and/or other criteria. The diagnostic system 400 may include at 420 a function whereby a system, by user prompt, will retrieve cases with similarities to a case assigned to the user. Similarities may be categorized by area of medicine, disease, type of specimen, and/or other criteria.

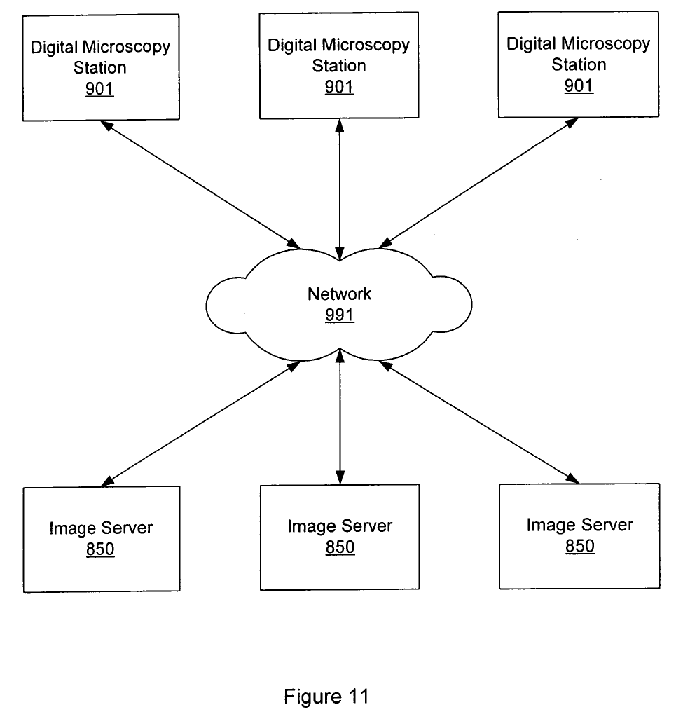

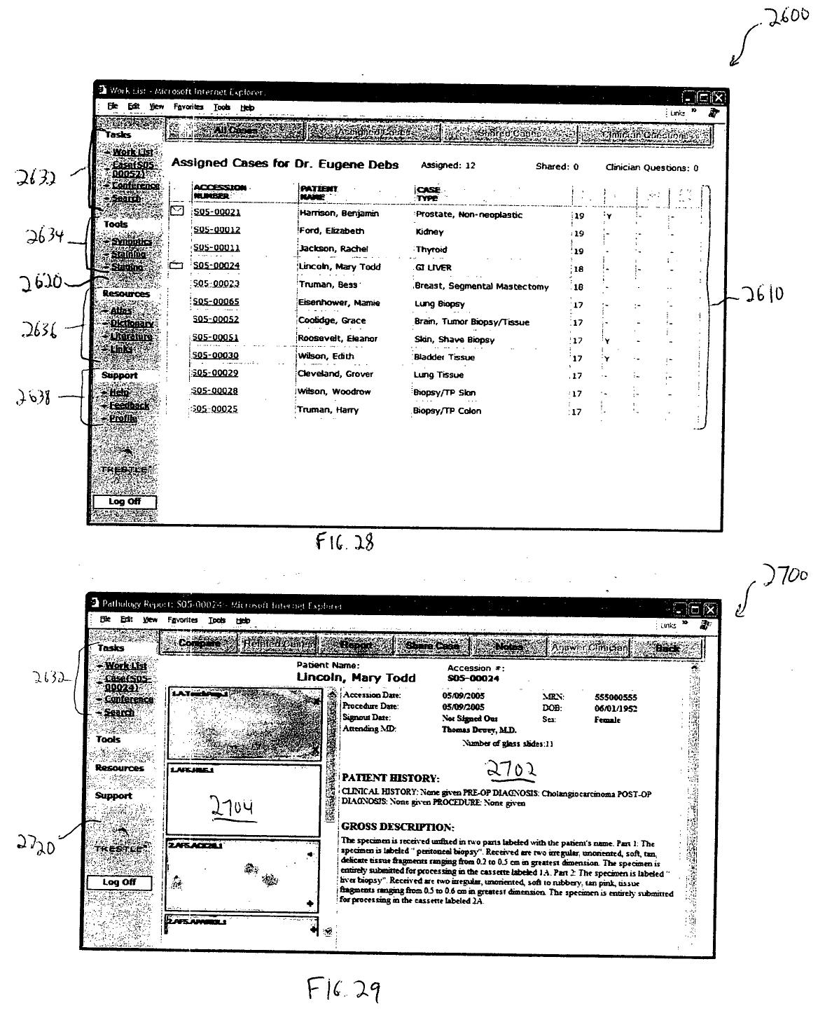

FIG. 28 illustrates an embodiment of a case list display 2600 that may be displayed at 420 to the user, such as a pathologist. The case list display 2600 may be shown, for example, by the monitor 208 of the image interface 200 embodiment of FIG. 6, or by a monitor of a digital microscopy station 901 embodiment of FIG. 11, or by a view station as described herein. The case list display 2600 may display a case list 2610 of one or more cases or studies. The one or more cases or studies may be categorized by an accession number, patient name, case type, and/or one or more other categories. The user may access a case, such as by mouse-clicking or otherwise following a hyperlink, for example, associated with the accession number or other portion of the case or study listing.

In an embodiment, the case list display 2600 further includes a case list display navigation bar 2620 showing a list of functions the user may employ by way of the image interface 200, for example, and which may include the accessing of slide images and other information on the diagnostic system 400 or the image system 799 of FIG. 9 in various embodiments. In various embodiments, the case list display navigation bar 2620 may include one or more of the following functions the user may employ, such as via hyperlink, and which may be associated with a case or study or other information: task functions 2632 such as to retrieve a user work list, access a specific case or study, engage in an online or other conference, and conduct a search; tool functions 2634 such as to enter or review a synopsis and to manage the staining and staging of a slide image; resource functions 2636 such as to access an online atlas, dictionary, literature, and/or one or more other information databases; and support functions 2638 such as to receive help regarding the system, provide feedback, and receive support regarding a user profile.

At 430, the user may select a case for review, such as by mouse-clicking a hyperlink or inputting the name of the case via an input device such as a computer keyboard. When a case has been selected, the diagnostic system 400 may, at 440, present the case for analysis by way of the imaging interface.

At 450, the user may analyze the case. The user at 450 may analyze the case by viewing information components of the case by way of the imaging interface in window form. In window form, specimen images and other case information may be viewed in windows that may be resized by the user dependent upon the information and/or images the user wishes to view. For example, at 450 the user may prompt the imaging interface to present, on the right half of the viewing screen, one or more images of tissue samples disposed on slides, and on the left half, text describing the medical history of the patient from which the specimen was removed. In one embodiment, the diagnostic system 400 may allow a user to view, at 450, multiple views at once of a tissue sample, or multiple tissue samples.

In one embodiment, the imaging interface may include a navigation bar that includes links to functions, such as Tasks, Resources, Tools, and Support, allowing the user to quickly access a function, such as by mouse-click. The specific functions may be customizable based upon the type of user, such as whether the user is a pathologist, toxicologist, histologist, technician, or administrator. The imaging interface may also include an action bar, which may include virtual buttons that may be “clicked” on by mouse. The action bar may include functions available to the user for the screen presently shown in the imaging interface. These functions may include the showing of a numbered grid over a specimen image, the showing of the next or previous of a series of specimens, and the logging off of the diagnostic system 400. The diagnostic system 400 may allow a user to toggle the numbered grid on and off.

FIG. 29 illustrates an embodiment of a case details display 2700 that may be presented to a pathologist or other user to be analyzed, such as described herein with respect to 440 and 450 of FIG. 3. The case details display 2700 in this embodiment may show details associated with a case or study of a pathologist or other user. The case details display 2700 may be shown, for example, by the monitor 208 of the image interface 200 embodiment of FIG. 6, or by a monitor of a digital microscopy station 901 embodiment of FIG. 11, or by a view station as described herein. The case details display 2700 may include a details summary 2702, which may include a patient or animal history, a gross description of the associated specimens, and/or other information associated with the case or study, such as dates of accession, procedure, and signout of the system, and information concerning the attending doctor, patient date of birth and sex, number of slides, and/or other information. The case details display 2700 may also include a slide image thumbnail display 2704, which a user may employ, such as via hyperlink, to view one or more of the slide images of the case or study. The case details display 2700 may also include a case details display navigation bar 2720, which may include one or more of the functions of the case list display navigation bar 2620 described above with respect to FIG. 28.

Returning to FIG. 3, in one embodiment, the diagnostic system 400 allows a user, such as via the navigation or action bar, to view an image of a specimen at multiple magnifications and/or resolutions. For example, with respect to a specimen that is a tissue sample, a user may prompt the diagnostic system 400 to display, by way of the imaging interface, a low magnification view of the sample. This view may allow a user to see the whole tissue sample. The diagnostic system 400 may allow the user to select an area within the whole tissue sample. Where the user has prompted the diagnostic system 400 to show a numbered grid overlaying the tissue sample, the user may select the area by providing grid coordinates, such as grid row and column numbers. The user may prompt the diagnostic system 400 to “zoom” or magnify that tissue area for critical analysis, and may center the area within the imaging interface. Where the user has prompted the system to show a numbered grid overlaying the tissue sample, the user may select the area by providing grid coordinates.

In one embodiment, the diagnostic system 400 allows a user, such as via navigation or action bar, to bookmark, notate, compare, and/or provide a report with respect to the case or cases being viewed. Thus, the user may bookmark a view of a specific area of a tissue sample or other specimen image at a specific magnification, so that the user may access that view at a later time by accessing the bookmark.

The diagnostic system 400 may also allow a user to provide notation on that view or another view, such as a description of the tissue sample or other specimen view that may be relevant to a diagnosis.

The diagnostic system 400 may also allow a user to provide a report relevant to the specimens being viewed. The report may be a diagnosis, and may be inputted directly into the diagnostic system 400.

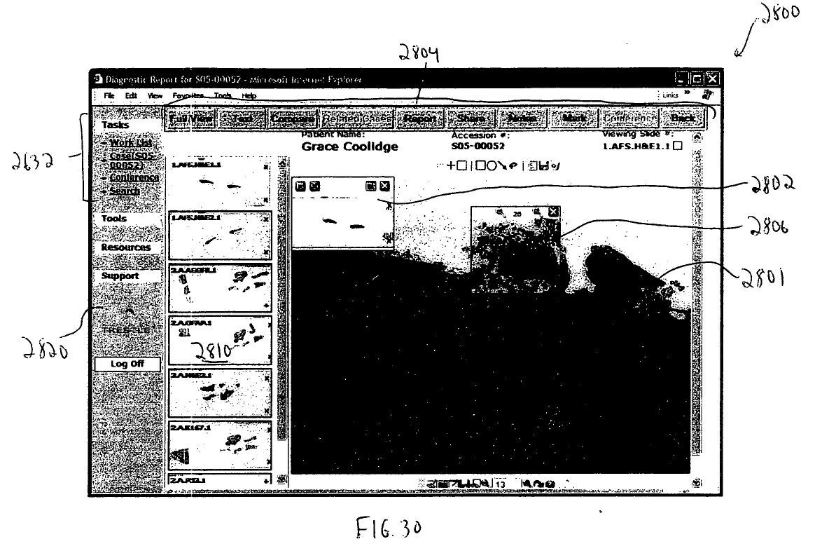

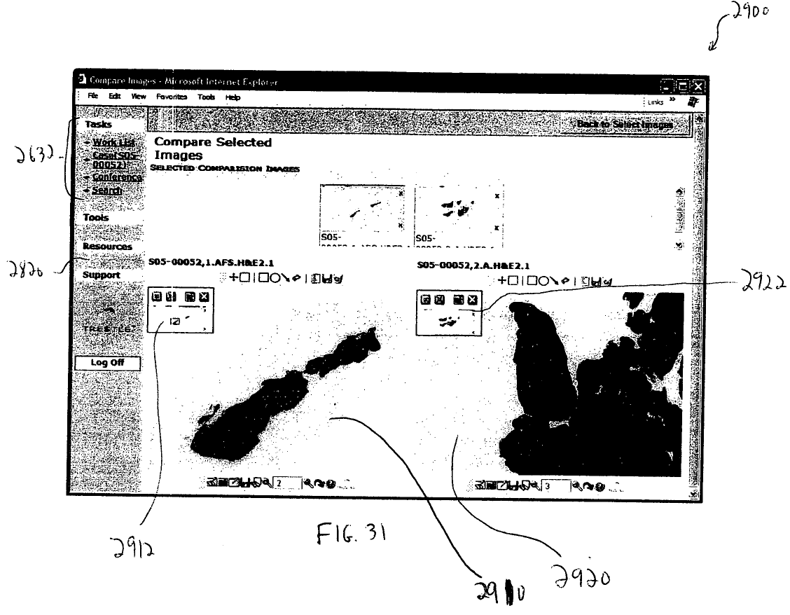

FIG. 30 illustrates an embodiment of an image viewing display 2800 the user may employ to view a magnified image or portion thereof 2801 of a tissue, such as described herein with respect to the diagnostic system 400 of FIG. 3. The image viewing display 2800 may show an image navigation window 2802 showing a macro view of the image, including, in an embodiment, a pointer or other indicator to indicate the magnified image or portion thereof 2801 being currently viewed. The macro view of the image may correspond to the low magnification view of the image described above with respect to the diagnostic system 400 of FIG. 3.

The image viewing display 2800 may include one or more image navigating buttons 2804 employable, such as by mouse-click, to navigate the image presently shown. In various embodiments, the image navigation buttons 2804 may include one or more of the following: a full view button to view the entire image such as a more magnified version of the image shown in the image navigation window 2802, for example; a text button to submit text associated with the image into the image interface 200 or other system; a compare button to compare the image with another image, a related cases button to view a list of related cases or studies; a report button to submit a report related to the image; a share button to transmit or otherwise share the image, such as in the current view and including notes, marks, and other case study information associated with the image, with another user; a notes button to submit notes associated with, and possibly superimposed on, the image; a mark button to mark a portion of the image, such as with a pointer or arrow superimposed on the image; a conference button to engage in conference with one or more other users online or otherwise, for example; and a back button return to the previous image view presented by the image viewing display 2800.

The image viewing display 2800 may also include an image magnifier window 2806 showing a portion of the magnified image or portion thereof 2801 but at a greater magnification. The magnified image portion in the image magnifier window 2806 may correspond to the “zoomed” or magnified tissue area for analysis as described above with respect to the diagnostic system 400 of FIG. 3.

The image viewing display 2800 may also include a slide image thumbnail display 2810 that may correspond to the slide image thumbnail display 2704 of FIG. 29, and a case list display navigation bar 2820, which may include one or more of the functions of the case list display navigation bar 2620 described above with respect to FIG. 28.

Returning to FIG. 3, the diagnostic system 400 may also allow a user to compare one specimen to another, such as via the compare button of the image navigation buttons 2804 of FIG. 30. The other specimen may or may not be related to the present case, since the diagnostic system 400 may allow a user to simultaneously show images of specimens from different cases.

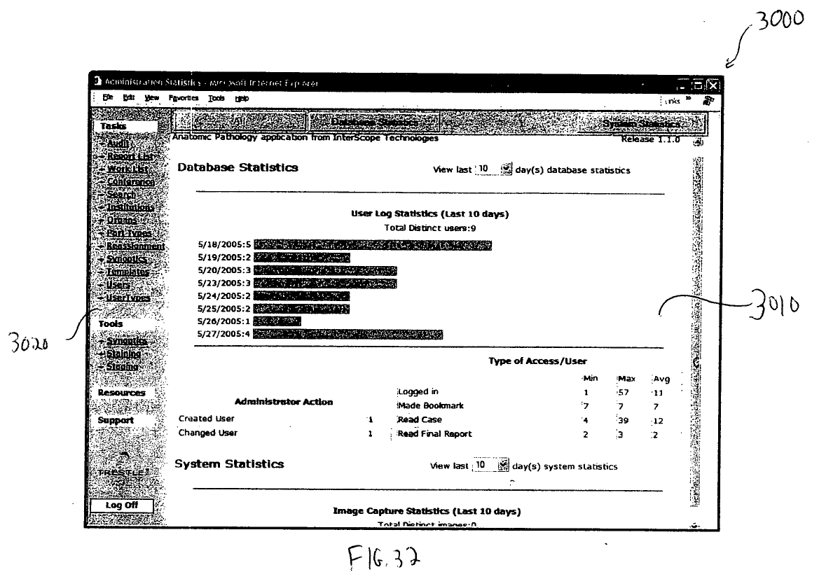

For example, FIG. 31 illustrates an embodiment of an image compare display 2900 that displays at least two magnified images or portions thereof 2910 and 2920 for comparison, such as side-by-side comparison, for example. In an embodiment, the two magnified images or portions thereof 2910 and 2920 are of specimens taken from a single organism in a case or study. In an embodiment, each of the magnified images or portions thereof 2910 and 2920 is independently navigable, such as described with respect to the magnified image or portion thereof 2801 of FIG. 30. For example, the magnified images or portions thereof 2910 and 2920 may include image navigation windows 2912 and 2922, respectively, each of which may correspond to the image navigation window 2802 of FIG. 30.

The diagnostic system 400 may track some or all of the selections the user makes on the diagnostic system 400 with respect to a case. Thus, for example, the diagnostic system 400 may record each location and magnification at which a user views an image of a specimen. The diagnostic system 400 may also record other selections, such as those made with respect to the navigation and action bars described above. The user may thus audit his or her analysis of the case by accessing this recorded information to determine, for example, what specimens the he or she has analyzed, and what parts of a single specimen he or she has viewed. Another person, such as a doctor or researcher granted access to this recorded information, may also audit this recorded information for purposes such as education or quality assurance/quality control.

Doctors and researchers analyze specimens in various disciplines. For example, pathologists may analyze tissue and/or blood samples. Hospital and research facilities, for example, may be required to have a quality assurance program. The quality assurance program may be employed by the facility to assess the accuracy of diagnoses made by pathologists of the facility. Additionally, the quality assurance program may gather secondary statistics related to a diagnosis, such as those related to the pathologist throughput and time to complete the analysis, and the quality of equipment used for the diagnosis.

A method of quality assurance in hospitals and research facilities may include having a percentage of case diagnoses made one or more additional times, each time by the same or a different diagnostician. In this method as applied to a pathology example, after a first pathologist has made a diagnosis with respect to a case, a second pathologist may analyze the case and make a second diagnosis. In making the second diagnosis, the second pathologist may obtain background information related to the case, the case including such information as the patient history, gross tissue description, and any slide images that were available to the first pathologist. The background information may also divulge the identity of the first pathologist, along with other doctors and/or researchers consulted in making the original diagnosis.

A reviewer, who may be an additional pathologist or one of the first and second pathologists, compares the first and second diagnoses. The reviewer may analyze any discrepancies between the diagnoses and rate any differences based upon their disparity and significance.

Such a method, however, may introduce bias or other error. For example, the second pathologist, when reviewing the background information related to the case, may be reluctant to disagree with the original diagnosis where it was made by a pathologist who is highly respected. Additionally, there is a potential for bias politically, such as where the original pathologist is a superior to, or is in the same department as, the second pathologist. In an attempt to remove the possibility of such bias, some hospitals and research facilities may direct technicians or secretaries to black out references to the identity of the first pathologist in the case background information. However, such a process is time-consuming and subject to human error.

Additionally, the reviewer in the quality assurance process may obtain information related to both diagnoses, and may thus obtain the identities of both diagnosticians. Knowing the identities may lead to further bias in the review.

Another potential source of bias or other error in the quality assurance process involves the use of glass slides to contain specimens for diagnosis. Where slides are used in the diagnostic process, the first and second pathologists may each view the slides under a microscope. Dependent upon the differences in the first and second diagnoses, the reviewer may also view the slides. Over time and use, the slides and their specimens may be lost, broken, or damaged. Additionally, one of the viewers may mark key areas of the specimen on the slides while analyzing them. Such marking may encourage a subsequent viewer to focus on the marked areas while ignoring others.

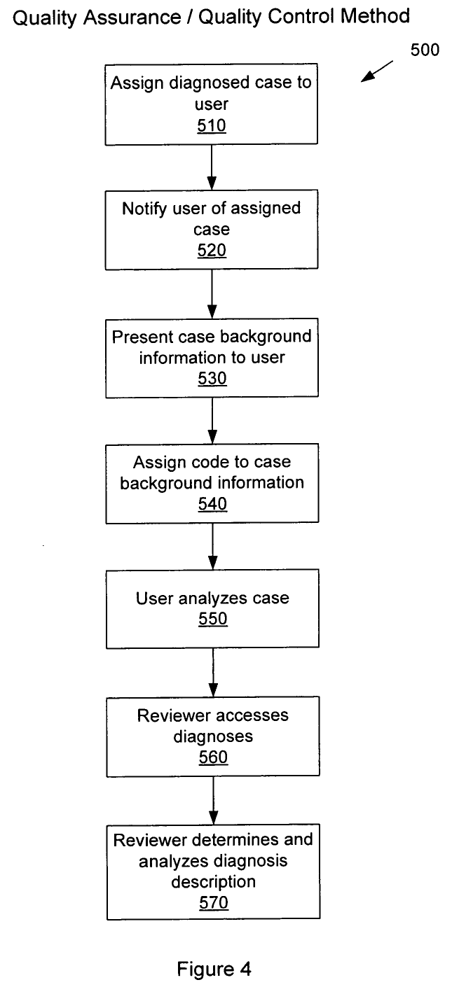

FIG. 4 is a flow chart of one embodiment of a method for providing a quality assurance/quality control (“QA/QC”) system 500 regarding diagnoses of medical samples or other specimens. The QA/QC system 500 may be included in the diagnostic system 400 described above. In this embodiment, the software of the QA/QC system 500 assigns, at 510, a diagnosed case to a user who may be a pathologist, although the case may be assigned to any number and classification of users, such as cytologists, toxicologists, and other diagnosticians. The assignor may be uninvolved in the quality assurance process for the case, in both a diagnostic and reviewing capacity, to ensure the anonymity of the process. The assignment may also be random with respect to the case and the user. The user may receive notification at 520, such as by email or by graphical notation within the imaging interface, that he or she has been assigned the case for diagnosis as part of the QA/QC process. At 530, the user may access the case background information, such as by logging on to the QA/QC system 500 with a user identification and password.

The QA/QC system 500 may make the diagnosis by the user “blind” by making anonymous sources of the case background information. Thus, the QA/QC system 500 may present the case background information at 530 without names such that the user cannot determine the identity of the original diagnostician and any others consulted in making the original diagnosis. Additionally, specimens and other case information may not include a diagnosis or related information or any notations or markings the initial diagnostician included during analysis of the case. However, these notations and markings may still be viewable by the original diagnostician when the original diagnostician logs into the QA/QC system 500 using his or her user identification and password.

The QA/QC system 500 may at 540 assign a random identification number or other code to the case background information so the user will know that any information tagged with that code is applicable to the assigned case.

The case background information may be the same information to which the original diagnostician had access. Thus, for example, where the specimens to be diagnosed are tissue samples disposed on glass slides, the user may access the same captured images of the tissue samples that the original diagnostician analyzed at 530, along with patient history information that was accessible to the original diagnostician.

In one embodiment the case background information available to the user may further include information entered by the original diagnostician, but edited to remove information identifying the original diagnostician.

The user may analyze the case at 550, in the same way as described with respect to 450 of the diagnostic system 400 of FIG. 3 above. In one embodiment, the QA/QC system 500 tracks some or all of the selections each diagnostician user makes on the QA/QC system 500 with respect to a case. Thus, for example, the QA/QC system 500 may record each location and magnification at which a user views an image of a specimen. The system may also record other selections, such as those made with respect to the navigation and action bars described above. The QA/QC system 500 may also record selections made by a reviewer.

After the diagnoses have been made by all users as per the QA/QC process, a reviewer, who may be a doctor or researcher who was not one of the diagnosticians of the case, may access and compare the diagnoses at 560. The reviewer may log in to the QA/QC system such as described above at 530. The reviewer may then, at 570, determine and analyze the discrepancies between the diagnoses and rate any differences based upon their disparity and significance. In one embodiment, the diagnostic information the reviewer receives is anonymous, such that the reviewer can neither determine the identity of any diagnostician nor learn the order in which the diagnoses were made. Providing such anonymity may remove the bias the reviewer may have had from knowing the identity of the diagnosticians or the order in which the diagnoses were made.

Where the reviewer determines that the discrepancy between diagnoses is significant, the reviewer may request that additional diagnoses be made. The QA/QC system 500 may also withhold the identity of the reviewer to provide reviewer anonymity with respect to previous and/or future diagnosticians.

In one embodiment, the QA/QC system 500 may substitute some or all of the function of the reviewer by automatically comparing the diagnoses and preparing a listing, such as in table form, of the discrepancies in some or all portions of the diagnoses. Alternatively, the reviewer may prompt the QA/QC system 500 to conduct such a comparison of diagnostic information that may be objectively compared, without need for the expertise of the reviewer. The reviewer may then review the other diagnostic information as at 570.

In one embodiment, the quality assurance method includes the collection and organization of statistical information in computer databases. The databases may be built by having diagnostic and review information input electronically by each diagnostician and reviewer into the QA/QC system 500. These statistics may include, for example, the number of cases sampled versus the total number processed during a review period; the number of cases diagnosed correctly, the number diagnosed with minor errors (cases where the original diagnoses minimally effect the patient care), and the number of cases misdiagnosed (cases where the original diagnoses have significant defects); the number of pathologists involved; and/or information regarding the number and significance of diagnostic errors with regard to each pathologist. Additional or alternative statistics may include the second pathologist used to make the second diagnosis, the time the reviewer used to review and rate the diagnoses, and/or the number of times the reviewer had to return to the case details before making a decision.

FIG. 32 illustrates an embodiment of an administrator statistics screen 3000 that an administrator may use to manage the QA/QC system 500 of FIG. 4, and add and delete users and modify their online information. The administrator statistics screen 3000 may include one or more employable functions that are not shown to, or employable by, non-administrator users. For example, the administrator statistics screen 3000 may provide a database statistics description 3010 including information such as statistics related to the image system and/or database including user logins, type of user access, type of user, and administrator actions. The administrator statistics screen 3000 may also include an administrator navigation bar 3020, which may include one or more of the functions of the case list display navigation bar 2620 described above with respect to FIG. 28, and may also include buttons employable for maintenance such as editing, and may include one or more of the following buttons: an audit button to review audit actions performed on a case and/or performed by a user, such as viewing an audit trail or other tracking of system usage such as described herein with respect to the image system 799 of FIG. 9; a reports list button to view a list of reports, such as those related to a case or study; an institutions button to view and/or edit information related to institutions associated with the system; an organs button for viewing information regarding the labeling of organs stored or otherwise addressed in the system; a part types button for viewing, editing, and/or defining a new source of specimens, such as “left lung,” for example; a reassignment button for reassigning a review or other task to another user; a templates button for viewing, editing, and/or creating a form that can be completed by a user, such as via an image interface 200, to create a preliminary report associated with a study or slide image or images; user and user types buttons for viewing and possibly manipulating information regarding the users and types of users of the image system 799, for example; and other buttons having other functions as desired.

FIG. 5 is a flow chart of one embodiment of a method for providing an educational system 600 for diagnosing medical samples or other specimens. The educational system 600 may provide student users with access at 610 to a system with the basic functionality of the diagnostic system 400 of FIG. 3. By employing the tracking function of diagnostic system 400, a teacher may at 620 audit the selections made by a student user in diagnosing an image of a specimen viewed in the imaging interface of diagnostic system 400. The teacher may view at 620, selection by selection, the selections made by each student. The teacher may then inform the student of proper and imprudent selections the student made.

The educational system 600 may include other information, such as notations with references to portions of specimen images, encyclopedic or tutorial text or image information to which a student user may refer, and/or other information or images that may that may educate a user in diagnosing the specimen.

FIG. 6 illustrates an embodiment of an imaging interface 200 that may be used to display one or more images and information related to images either simultaneously or separately. The imaging interface 200 of that embodiment includes memory 202, a processor 204, a storage device 206, a monitor 208, a keyboard or mouse 210, and a communication adaptor 212. Communication between the processor 204, the storage device 206, the monitor 208, the keyboard or mouse 210, and the communication adaptor 212 is accomplished by way of a communication bus 214. The imaging interface 200 may be used to perform any function described herein as being performed by other than a human and may be used in conjunction with a human user to perform any function described herein as performed by such a human user.

It should be recognized that any or all of the components 202-212 of the imaging interface 200 may be implemented in a single machine. For example, the memory 202 and processor 204 might be combined in a state machine or other hardware based logic machine.

The memory 202 may, for example, include random access memory (RAM), dynamic RAM, and/or read only memory (ROM) (e.g., programmable ROM, erasable programmable ROM, or electronically erasable programmable ROM) and may store computer program instructions and information. The memory may furthermore be partitioned into sections including an operating system partition 216 in which operating system instructions are stored, a data partition 218 in which data is stored, and an image interface partition 220 in which instructions for carrying out imaging interface functions are stored. The image interface partition 220 may store program instructions and allow execution by the processor 204 of the program instructions. The data partition 218 may furthermore store data such as images and related text during the execution of the program instructions.

The processor 204 may execute the program instructions and process the data stored in the memory 202. In one embodiment, the instructions are stored in memory 202 in a compressed and/or encrypted format. As used herein the phrase, “executed by a processor” is intended to encompass instructions stored in a compressed and/or encrypted format, as well as instructions that may be compiled or installed by an installer before being executed by the processor 204.

The storage device 206 may, for example, be a magnetic disk (e.g., floppy disk and hard drive), optical disk (e.g., CD-ROM) or any other device or signal that can store digital information. The communication adaptor 212 permits communication between the imaging interface 200 and other devices or nodes coupled to the communication adaptor 212 at the communication adaptor port 224. The communication adaptor 212 may be a network interface that transfers information from nodes on a network to the imaging interface 200 or from the imaging interface 200 to nodes on the network. The network may be a local or wide area network, such as, for example, the Internet, the World Wide Web, or the network 250 illustrated in FIG. 7. It will be recognized that the imaging interface 200 may alternately or in addition be coupled directly to one or more other devices through one or more input/output adaptors (not shown).

The imaging interface 200 is also generally coupled to output devices 208 such as, for example, a monitor 208 or printer (not shown), and various input devices such as, for example, a keyboard or mouse 110. Moreover, other components of the imaging interface 200 may not be necessary for operation of the imaging interface 200. For example, the storage device 206 may not be necessary for operation of the imaging interface 200 as all information referred to by the imaging interface 200 may, for example, be held in memory 202.

The elements 202, 204, 206, 208, 210, and 212 of the imaging interface 200 may communicate by way of one or more communication busses 214. Those busses 214 may include, for example, a system bus, a peripheral component interface bus, and an industry standard architecture bus.

A network in which the imaging interface may be implemented may be a network of nodes such as computers, telephony-based devices or other, typically processor-based, devices interconnected by one or more forms of communication media. The communication media coupling those devices may include, for example, twisted pair, co-axial cable, optical fibers, and wireless communication methods such as use of radio frequencies. A node operating as an imaging interface may receive the data stream 152 from another node coupled to a Local Area Network (LAN), a Wide Area Network (WAN), the Internet, or a telephone network such as a Public Switched Telephone Network (PSTN), or a Private Branch Exchange (PBX).

Network nodes may be equipped with the appropriate hardware, software, or firmware necessary to communicate information in accordance with one or more protocols, wherein a protocol may comprise a set of instructions by which the information is communicated over the communications medium.

FIG. 7 illustrates an embodiment of a network 250 in which the imaging interface may operate. The network may include two or more nodes 254, 256, 258, 260 coupled to a network 252 such as a PSTN, the Internet, a LAN, a WAN, or another network.

The network 250 may include an imaging interface node 254 receiving a data stream such as image related information from a second node such as the nodes 256, 258, and 260 coupled to the network 252.

One embodiment relates to a system and method for digital slide processing, archiving, feature extraction and analysis. One embodiment relates to a system and method for querying and analyzing network distributed digital slides.

Each networked system, according to one embodiment, includes an image system 799, which includes one or more imaging apparatuses 800 and an image server 850, and one or more digital microscopy stations 901, such as shown in and described with respect to FIGS. 9 through 11. In various embodiments, the image system 799 may perform or facilitate performance of some or all parts of each of the methods described with respect to FIGS. 1-5 and 8.

An imaging apparatus 800 may be a device whose operation includes capturing, such as at 110 of FIG. 1, by scanning or otherwise imaging, a digital image of a slide or a non-digital image that is then converted to digital form. An imaging apparatus 800 may include an imager 801 for scanning or otherwise capturing images, one or more image compressors/archivers 803 to compress and store the images, and one or more image indexers 852 to process and extract features from the slide. In an embodiment, features may be described by two values or a vector. The two values may be, for example, texture and roundness that correspond, for example, to nuclear mitotic activity and cancerous dysplasia, respectively.

In one embodiment an imager 801, such as a MedScan™ high speed slide scanner from Trestle Corporation, based in Irvine, Calif., includes a high resolution digital camera 802, microscope optics 807, motion hardware 806, and a controlling logic unit 808. Image transport to a storage device may be bifurcated either at camera level or at system level such that images are sent both to one or more compressors/archivers 803 and to one or more image indexers 852. In an embodiment including bifurcation at the camera level as may be demonstrated with respect to FIG. 9, the output from the camera by way of Ethernet, Firewire USB, wireless, or other communication protocol may be simultaneously transmitted, such as through multicasting, so that both the compressor/archiver 803 and the image indexer 852 receive a copy of the image. In an embodiment including bifurcation at the system level, images may exist in volatile RAM or another high speed temporary storage device, which may be accessed by the compressor/archiver 803 and the image indexer 852.

In one embodiment, the imager 801 includes a JAI CV-M7CL+ camera as the camera 802 and an Olympus BX microscope system as the microscope optics 807 and is equipped with a Prior H101 remotely controllable stage. The Olympus BX microscope system is manufactured and sold by Olympus America Inc., located in Melville, N.Y. The Prior H101 stage is manufactured and sold by Prior Scientific Inc., located in Rockland, Mass.

In one embodiment, the image compressor/archiver 803 performs a primary archiving function and may perform an optional lossy or lossless compression of images before saving the images to storage devices 854. In one embodiment, slide images may be written, such as by compressor/archiver 803, in JPEG in TIFF, JPEG2000, or JPEG2000 in TIFF files using either one or more general purpose CPUs or one or more dedicated compression cards, which the compressor/archiver 803 may include. Original, highest resolution images may be stored together with lower resolution (or sub-band) images constructed from the highest resolution images to form a pyramid of low to high resolution images. The lower resolution images may be constructed using a scale down and compression engine such as described herein, or by another method. To accommodate any file size limitation of a certain image file format (such as the 4 GB limit in a current TIFF specification), the slide image may be stored, in a storage device 854, in multiple smaller storage units or “storage blocks.”

An image compressor/archiver 803 may also provide additional processing and archiving of an image, such as by the generation of an isotropical Gaussian pyramid. Isotropical Gaussian pyramids may be employed for many computer vision functions, such as multi-scale template matching. The slide imaging apparatus 800 may generate multiple levels of the Gaussian pyramid and select all or a subset of the pyramid for archiving. For example, the system may save only the lower resolution portions of the pyramid, and disregard the highest resolution level. Lower resolution levels may be significantly smaller in file size, and may therefore be more practical than the highest resolution level for archiving with lossless compression or no compression. Storage of lower resolution levels, in a storage device 854, in such a high fidelity format may provide for enhanced future indexing capability for new features to be extracted, since more data may be available than with a lossy image. A lossy or other version of the highest resolution image may have been previously stored at the time the image was captured or may be stored with the lower resolution images.

In alternate embodiments of the imaging apparatus 800, the highest resolution images may be kept in storage devices 854 in a primary archive, while the lower resolution versions, such as those from a Gaussian pyramid, may be kept in a storage or memory device of the slide image server 850, in a cache format. The cache may be set to a predetermined maximum size that may be referred to as a “high water mark” and may incorporate utilization statistics as well as other rules to determine the images in the archive for which lower resolution images are to be kept, and/or which components of the lower resolution images to keep. An example of a determination of what images to keep in cache would be the retention of all the lower resolution images for images that are accessed often. An example of a determination of what components of images to keep in cache would be the retention of only the resolution levels for the images that are frequently accessed. The two determinations may be combined, in one embodiment, such that only frequently used resolution levels for frequently accessed files are kept in cache. Other rules, in addition or alternative to rules of access, may be employed and may incorporate some a priori knowledge about the likely utility of the images or components of images to image processing algorithms, as well as the cost of the regeneration of the image data. That is, image data that is highly likely to be used by an image processing algorithm, and/or is highly time intensive to regenerate, may be higher in the priority chain of the cache.

The image indexer 852, which in one embodiment may also be known as the image processor/feature extractor, may perform user definable analytical processes on an image. The processes may include one or more of image enhancement, the determination of image statistics, tissue segmentation, feature extraction, and object classification. Image enhancement may include, for example, recapturing all or portions of an image using new capture parameters such as focal length or lighting level. Image statistics may include, for example, the physical size of the captured image, the amount of memory used to store the image, the parameters used when capturing the image, the focal lengths used for various portions of the captured image, the number of resolutions of the image stored, and areas identified as key to diagnoses. Tissue segmentation may include the size and number of tissue segments associated with a slide or case. Feature extraction may be related to the location and other information associated with a feature of a segment. Object classification may include, for example, diagnostic information related to an identified feature. Computing such properties of image data during the imaging process may afford significant efficiencies. Particularly with respect to steps such as the determination of image statistics, determining the properties in parallel with imaging may be far more efficient than performing the same steps after the imaging is complete. Such efficiency may result from avoiding the need to re-extract image data from media, uncompress the data, format the data, etc. Multiple image statistics may be applied in one or more colorspaces (such as HSV, HIS, YUV, and RGB) of an image. Examples of such statistics include histograms, moments, standard deviations and entropies over specific regions or other similar calculations that are correlated with various physiological disease states. Such image statistics may not necessarily be computationally expensive but may be more I/O bound and therefore far more efficient if performed in parallel with the imaging rather than at a later point, particularly if the image is to be compressed.

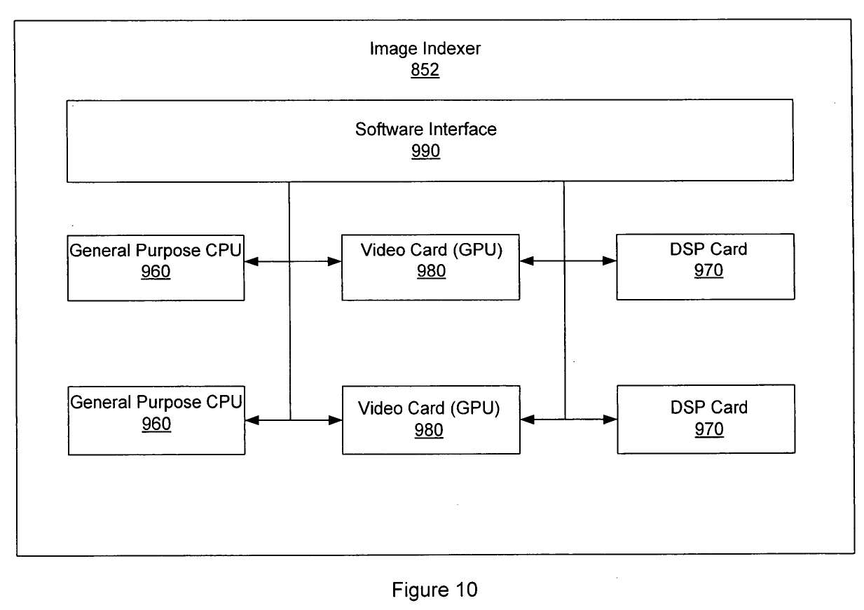

In one embodiment as shown in FIG. 10, an image indexer 852 may include one or more general purpose CPUs 960, digital signal processing boards 970, or graphics processing units (GPUs) 980, which may be included in one or more video cards. Examples of general purpose CPUs 960 include the x86 line from Intel Corporation, and the Power series from IBM Corporation. An example of a digital signal processing board 970 is the TriMedia board from Philips Corporation. It may be estimated that the processing power of GPUs in modern video cards roughly doubles every 6 months, versus 18 months for general purpose CPUs. With the availability of a high level graphics language (such as Cg from Nvidia Corporation, based in Santa Clara, Calif.), the use of GPUs may become more and more attractive. The software interface 990 of the image indexer 952 may schedule and direct different operations to different hardware for the most efficient processing. For example, for performing morphological operations with an image indexer 852 as in FIG. 9, convolutional filters may be best suited for digital signal processing (DSP) cards 970, certain types of geometrical transformations may be best suited for GPUs 980, while high level statistical operations may be best suited for CPUs 960.

In one embodiment, the image compressor/archiver 803 and the image indexer 852 share the same physical processing element or elements to facilitate speedy communication.

Different types of tissues (e.g., liver, skin, kidney, muscle, brain, eye, etc.) on slides may employ different types of processing for capture of tissue images. Thus, the user may designate a type for each tissue sample on a slide, or the system may automatically retrieve information about the slide in order to determine tissue sample classification information. Classification information may include multiple fields, such as tissue type, preparation method (e.g. formalin fixed, frozen, etc), stain type, antibody used, and/or probe type used. Retrieval of classification information may be accomplished in one of several ways, such as by reading a unique slide identification on the slide, such as RFID or barcode, or as otherwise described herein as desired, or by automatic detection through a heuristic application. In one embodiment, the unique slide identification or other retrieved information does not provide direct classification information, but only a unique identifier, such as a unique identifier (UID), a globally unique identifier (GUID), or an IPv6 address. These identifiers may be electronically signed so as to prevent modification and to verify the authenticity of the creator. This unique identifier may be used to query an external information system, such as a LIS, or LIMS as described herein, to provide the necessary specimen classification information.

The output, or a portion thereof, of the image indexer 852 may be, in one embodiment, in the form of feature vectors. A feature vector may be a set of properties that, in combination, provide some relevant information about the digital slide or portion thereof in a concise way, which may reduce the size of digital slide and associated information down to a unique set of discriminating features. For example, a three-dimensional feature vector may include values or other information related to cell count, texture, and color histogram.

For faster or maximum accuracy and speed, the image indexer may operate on a raw or lossless compressed image. However, certain operations may produce acceptable results with lossy compressed images.

In one embodiment, for certain classifications of liver tissue samples, for example, color saturation may be used by an image indexer 852 to detect glycogenated nuclei in the tissue, since these nuclei are “whiter” than normal nuclei. An adaptive threshold technique using previously saved image statistical information (such as histogram in HSV colorspace) may be used by an image indexer 852 to separate the glycogenated nuclei from normal nuclei. Each nucleus' centroid position, along with other geometric attributes, such as area, perimeter, max width, and max height, and along with color intensities, may be extracted by the image indexer 852 as feature vectors. In another embodiment, some combination of geometric attributes, color intensities, and/or other criteria may be extracted as feature vectors.

The results from the image processor/feature extractor, or image indexer 852, along with slide metadata (such as subject id, age, sex, etc.) and a pointer to the location of the image in the storage device may form a digital slide entity, such as described below, to be stored in a database, such as the image server 850.

The image compressor/archiver 803 may output intermediate results to the image indexer 852 while the multi-resolution image pyramid is being constructed. Feature vectors may then be extracted by the image indexer 852 at every resolution or selected resolutions to benefit future multi-resolution/hierarchical analysis/modeling.

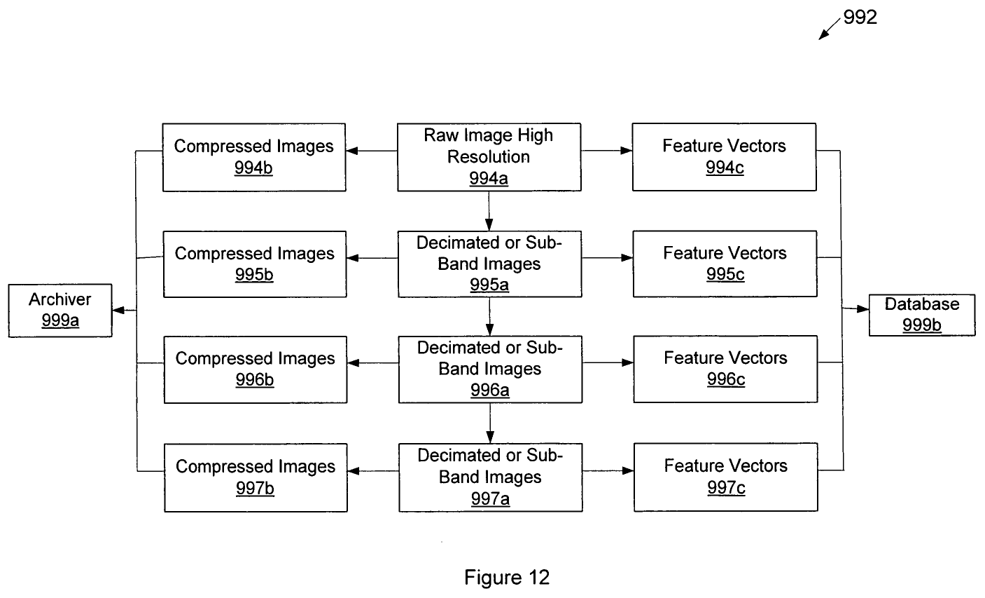

FIG. 12 illustrates a flow chart of an example of an image processing method 992, in accordance with one embodiment. The image processing method 992 may be performed, for example, by an image control system, such as the image system 799 embodiment described with respect to FIG. 9. The imager 801 of the image system 799 may, at 994a, capture a high resolution raw image of a slide and transmit the image to one or more compressors/archivers 803 and to one or more image indexers 852, such as simultaneously or otherwise as described herein, for example. The one or more compressors/archivers 803 may, at 994b, compress the high resolution raw image and, at 999a, archive the image. The one or more image indexers 852 may, at 994c, extract feature vectors from the high resolution raw image and, at 999b, store the feature vectors in a database.

At 995a, image system 799 may process the high resolution raw image and construct a decimated or sub-band image therefrom. The processes of compressing and extracting feature vectors, as in 994b and 999a, and 994c and 999b, may be repeated by the one or more compressors/archivers 803 and by the one or more image indexers 852 at 995b and 999a, and 995c and 999b, respectively, and with respect to the decimated or sub-band image constructed at 995a.

At 996a, the image system may process the decimated or sub-band image from 995a and construct therefrom another decimated or sub-band image. The compression/archiving and extracting and storing feature vector processes may be repeated for the other decimated or sub-band image at 996a at 996b and 999a, and 996c and 999b, respectively.

This process may be repeated at 997a, 997b and 999a, and 997c and 999b.

In an embodiment, the image server 850 may include one or more storage devices 854 for storing slide images, and a relational or object oriented database or other engine 851 for storing locations of slide images, extracted feature vectors from the slide, metadata regarding slides, and system audit trail information

The archived compressed image and feature vectors in the database may be accessible, such as through the image server 850, such as described with respect to FIG. 9.

An image server 850 may be used to store, query and analyze digital slide entities. A digital slide entity includes, in one embodiment, one or more slide images, feature vectors, related slide metadata and/or data, and audit trail information. Audit trail information may include, for example, recorded information regarding the selections a user makes in employing the system to diagnose a case, such as described herein with respect to the diagnostic system 400 of FIG. 3. The image server 850 may include one or more storage devices 854 for slide images, a relational or object oriented database or other engine 851 for storing locations of slide images, extracted feature vectors from the slide, metadata regarding slides, and system audit trail information. The digital slide server 150 may also be part of a network, such as the network 252 described herein with respect to FIG. 7, and may include one or more smart search agents 860 to perform query and analysis upon request. A smart search agent 860 may retrieve stored images. The image server 850 may also maintain and enforce user privileges, data integrity, and security. To provide security and protect the privacy of the data, different entries in the same digital slide entity may be assigned with different privilege requirements. For example, to satisfy government privacy requirements, patient identification information may not be available (or only be available as a hashed value, or a value associated with a person but not identifying the person to a user) to users outside of the organization. A fee-for-service framework, such as a fee matrix for different types of query/analysis operations, may be included in the image server 850 for accounting purposes.

In one embodiment, certain supervised and/or unsupervised neural network training sessions run in the image server 850. Examples of such neural network functions that may run include automatic quality assurance, which may include functionality of, and/or be employed with, the QA/QC system 500 of FIG. 4, and automatic diagnosis, such as may be employed with respect to the diagnostic system 400 of FIG. 3, using human diagnosis as feedback. An administrator, who may be, for example, an IT professional, may set up and/or modify the networks. Where increased training efficiency is desired, feature vectors may be moved from multiple image servers 850 to a single image server 850 to be accessed during training.

To assist with effective processing, an extensive, hierarchical caching/archiving system may be utilized with, and coupled with, the imaging apparatus 800 and the image server 850. For example, raw images fed from a scanner or other imager 801 may stay in volatile memory for a short time while various processing functions are performed. When the available volatile memory falls below a certain threshold (also known as a “low water mark”), images may be moved to fast temporary storage devices, such as high speed SCSI Redundant Array of Independent Disks (RAID) or FibreChannel Storage Area Network devices. After all initial processing is done, images may be compressed and moved to low cost but slower storage devices (such as regular IDE drives) and may eventually be backed up to a DLT tape library or other storage device. On the other hand, when and if a large amount of volatile memory becomes available (over a certain high water mark), some speculative prediction may be performed to move/decompress certain images to volatile memory/faster storage for future processing.

When multiple image servers 850 are used, data replication may become desirable. Smart replication functionality may be invoked, as there may be much redundancy, for example, in the image data and metadata. Such a smart replication technique may transmit only parts of the image or other data and reconstruct other parts based upon that transmitted data. For example, a low resolution image may be re-constructed from a higher resolution image, such as desired or described herein, such as by software that constructs Gaussian pyramids or other types of multi-resolution pyramids, such as in JPEG in TIFF or JPEG2000 in TIFF. In deciding what data to send, and what not to send but rather to reconstruct, one may weight the processing time, power, or cost to reconstruct an image or portion thereof verses the transmission time or cost to retrieve or transmit the image data from storage. For example, over a high speed local area network (LAN) or high speed Gigabit wide area network (WAN), complete feature vector construction, metadata replication, and image copying (if the security privilege requirement is satisfied) may be a sensible approach from an economic and/or time perspective. On the other hand, over slower Internet or other Wide Area Network (such as a standard 1.5 mbps T1) connections, it may be sensible that only metadata and certain feature vectors are replicated, while images are left on the remote location, such as the image server 850. When query/processing functions are requested in the future, certain operations that need the image data may be automatically delegated to the remote smart search agents 860.

In one embodiment, certain cost metrics may be associated with each type of processing and transmission. For example, the cost metrics may include one coefficient for transmission of 1 MB of image data and another coefficient for decompression and retrieval of 1 MB of image data. A global optimizer may be utilized to minimize the total cost (typically the linear combination of all processing/transmission amounts using the above mentioned coefficients) of the operation. These cost coefficients may be different from fee matrices used for accounting purposes.

In one embodiment of a digital slide server 850, a Network Attached Storage (NAS) from IBM may be used as a storage device 854, an Oracle Relation Database from Oracle may be used as a database engine 851, and several IBM compatible PCs or Blade workstations together with software programs or other elements may serve as smart search agents 860. These devices may be coupled through a high speed local area network (LAN), such as Gigabit Ethernet or FibreChannel, and may share a high speed Internet connection.

A digital microscopy station 901, such as illustrated in FIG. 11, may, in an embodiment, comprise a workstation or other instrument, such as the image interface 200 described with respect to FIG. 6, or vice versa, and may be to review, analyze, and manage digital slides, and/or provide quality assurance for such operations. A digital microscopy station 901 may include one or more high resolution monitors, processing elements (CPU), and high speed network connections. A digital microscopy station 901 may connect to one or more image servers 850 during operation. It may also communicate with other digital microscopy stations 901 to facilitate peer review, such as the peer review described with respect to the QA/QC system 500 described with respect to FIG. 4.

In an embodiment, the digital microscopy station 901 is used to operate a camera operating to capture an image of a tissue or specimen at a remote location, such as through one or more magnifying lenses and by using a motorized stage. The digital microscopy station 901 may permit its user to input image capture control parameters, such as lens selection, portion of tissue or specimen desired to be viewed, and lighting level. The digital microscopy station 901 may then transmit those parameters to a slide imaging apparatus 800 through a network such as the network 991 illustrated in FIG. 11. The slide imaging apparatus may then capture one or more images in accordance with the control parameters and transmit the captured image across the network to the digital microscopy station.

In one embodiment, a digital microscopy station 901 may receive and transmit a request related to a case and which includes instructions and input from a user, and constructs a set of query/analysis commands, which are then sent to one or more image servers 850. The request may be a request for a slide image and other information related to a case. The commands may include standard SQL, PL/SQL stored procedure and/or Java stored procedure image processing/machine vision primitives that may be invoked in a dynamic language, such as a Java applet.

In one embodiment, a digital microscopy station 901 may include an enhanced MedMicroscopy Station from Trestle Corporation, based in Irvine, Calif.

An alternative embodiment of a microscopy station 901 is a Web browser-based thin client, which may utilize a Java applet or another dynamic language to communicate capture parameters or receive an image.

Upon receiving the request, the image server 850 may check and verify the credentials and privileges of the user associated with the request. Such credentials and privileges may be accomplished by way of encryption or a password, for example. Where the credentials and privileges are not appropriate for access to requested case information, the image server 850 may reject the request and notify the user of rejection. Where the credentials and privileges are appropriate for access, the image server 850 may delegate the query tasks to the relational or object oriented database engine 851 and image processing/machine vision function to the dedicated smart search agents 860. The results of the query may be returned to the digital microscopy station 901 that provided the request and/or one or more additional digital microscopy stations 901 where requested. The tasks may be performed synchronously or asynchronously. Special privileges may be required to view and/or change the scheduling of concurrent tasks.

In one embodiment, users are divided into technicians, supervisors and administrators. In this embodiment, while a technician may have the privilege to view unprotected images, only a supervisor may alter metadata associated with the images. Unprotected images may be, for example, the images that are reviewed at 152 of FIG. 2 to confirm the images are appropriate for review or amenable to diagnosis. In that embodiment, only an administrator may assign and/or alter the credentials and privileges of another user and audit trail information may not be altered by anyone.

To protect the privacy and integrity of the data stored in the image server 850, a form of secure communication may be utilized between the digital microscopy station 901 and image server 850 and among multiple image servers 850. One embodiment may be based on Secure Socket Layer (SSL) or Virtual Private Network (VPN). User accounts may be protected by password, passphrase, smart card and/or biometric information, for example.

The following are some examples of common tasks that may be performed at a digital microscopy station 901. In one embodiment, a user may employ the digital microscopy station 901 to visually inspect a set of digital slides or images. The user may prompt the digital microscopy station 901 to query or otherwise search for the set, such as by, for example, searching for all images of liver tissues from a particular lab that were imaged in a given time frame. The user may also prompt the digital microscopy station 901 to download or otherwise provide access to the search results. The user may also or alternatively find and access the set by a more complex query/analysis (e.g., all images of tissue slides meeting certain statistical criteria). A user may employ statistical modeling, such as data mining, on a class or set of slide images to filter and thus limit the number of search results. The credentials and privileges of a user may be checked and verified by the image server 850 the user is employing. The user may request a subset of the accessed images to be transmitted to another user for real time or later review, such as collaboration or peer consultation in reaching or critiquing a diagnosis of the user. The user may execute the search before he or she plans to view the search results, such as a day in advance, to allow for download time. The cost of the diagnostic and/or review operations may be calculated according to an established fee matrix for later billing.

In one example of searching, accessing, and filtering functions, a user may employ a digital microscopy station 901 to query an image server 850 to select all images of liver tissues that have a glycogenated nuclei density over a certain percentage, and to retrieve abnormal regions from these tissue images. Other thresholds may be specified in a query such that images of tissues having the borderline criteria may be sent to another user at another digital microscopy workstation 901 for further review.

In one embodiment, the digital microscopy station 901 may be prompted to automatically perform one or more searching, accessing, and filtering functions at a later time based upon certain criteria. For example, the user may prompt the digital microscopy station 901 to automatically and periodically search the image server 850 for all tissue samples meeting a certain criteria and then download any new search results to the digital microscopy station 901.

In one embodiment, one image server 850 at one of the geographic locations of an organization associated with the system, such as a hospital branch, has multiple slide imaging apparatuses 800 or other slide imagers having slides provided regularly for imaging. Technicians at this location may use digital microscopy stations 901 to perform quality assurance and/or quality control, while pathologists or other diagnosticians at another location may use digital microscopy stations 901 to review and analyze the slide images and effectively provide a remote diagnosis. The technicians and diagnosticians may process the images, in one embodiment, through the processes of the image management system 150 of FIG. 2 and the diagnostic system 400 of FIG. 3.

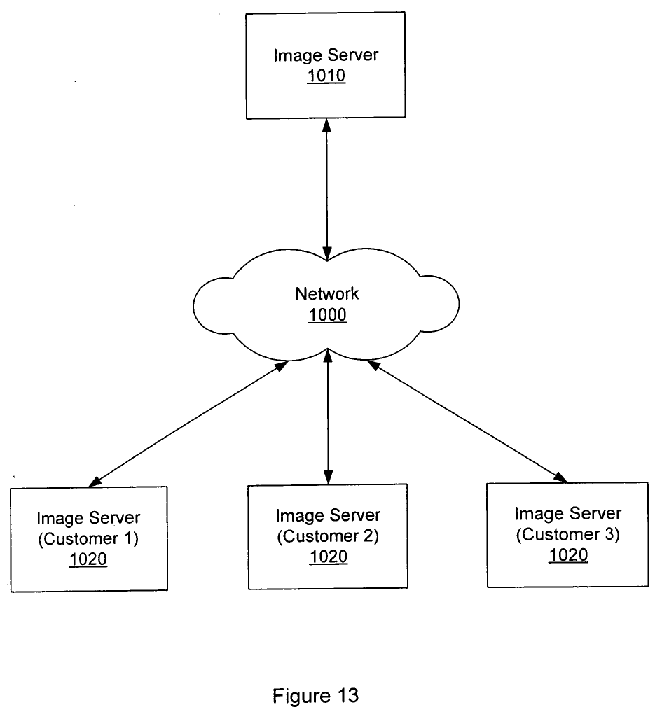

Such a server/client model, employing an image server 850 and digital microscopy stations 901, may include an outsourced imaging laboratory, such as the Trestle ePathNet service and system from Trestle Corporation. In one embodiment of an imaging network 1000, as shown in FIG. 13, a Trestle ePathNet or other server, which may provide pathology data management and virtual microscopy functionality, includes a master image server 1010. The master image server 1010 may include functionality of an image server 850 or portion thereof, while multiple slave image servers 1020 at different customer sites (such as Pharmaceutical companies and Biotechnology laboratories) may each include functionality of an image server 850 or portion thereof. Imagers 801, along with image archivers/compressors 803 and image indexers 852, at customer sites, may each output images as well as feature vectors to the slave image server 1020 to which that imager 801 is coupled.

One or more smart search agents 860 may be located on or in close proximity to the customer's slave image server 1020. Image metadata and predefined feature vectors stored on a slave image server 1020 may be replicated and transmitted to a facility that includes a master image server 1010, such as Trestle's ePathnet server, using a secure communication method, such as SSL or VPN, or another communication method. Query/analysis functions may be commanded, such as via a digital microscopy station 901, to be executed at least partially by smart search agents 860 at the facility. The smart search agents 860 at the facility may then search for and analyze any image metadata and predefined feature vectors stored on the master image server 1010 and/or search for and retrieve data from the slave image server 1020. The smart search agents 860 at the facility may alternatively or additionally delegate tasks to client side, or customer side, smart search agents 860, which may analyze information on a database, which may be on the slave image server 1020, at a customer's facility.

Data transported from a customer site or facility to a master image server 1010, such as at a Trestle facility, may be deidentified data, which may be data in which fields a user has defined as identifying have been removed, encrypted, hashed using a one-way hash function for example such that the identification of the user may not be determined, or translated using a customer controlled codebook. In one embodiment, the deidentified data may be specified automatically by a software program. Using smart replication techniques, offsite database storage and limited image storage may be facilitated. To save bandwidth, primary image storage means, such as a slave image server 1020 having ample storage capacity, may be located at a customer site and may store feature vectors, metadata, and certain lower resolution representations of the slide images that may be replicated at a master image server 1010, such as Trestle Corporation's ePathNet Server, via smart replication. In an embodiment, most or another portion of the high level modeling/data mining may be performed on a powerful master server, such as the ePathNet Server, to limit the amount of analysis on a customer's server, such as a slave image server 1020.

In the digital workplace, various system designs may be employed. For example, streaming images to a view station on an as-needed basis is one process that may be used. Where faster access is desired, the images may be stored locally at the view station computer. But, manual or scripted copying of whole digital slides may be cumbersome, and may not be not network adaptive (e.g., where a system requires a user to download either the whole image file or nothing).

In one embodiment, a system and method is to transport image data for use in creating virtual microscope slides, and may be employed to obtain magnified images of a microscope slide. In this embodiment, the system and method combines of the functionality of both streaming images to and storing images on a computer system in which the images may be viewed. In another embodiment of the system and method, a portion of an image of a slide may be streamed or downloaded to the view station. These embodiments may facilitate more rapid review of a digital slide or slides.

To construct a method employed by a system according to one embodiment, one may begin by examining the anticipated workflow. In the digital workplace, slides may be imaged and stored, such as on the image server 850 described herein or another server, for example, and additional information regarding the slides may also be entered into a database on the server. Next, the data may be reviewed. According to one embodiment, to the extent it is known who is likely to review the data and where that person is located, a system and method may be architected to provide appropriate images and related data to users at appropriate locations more efficiently.

In that embodiment, the system may “push” or “pull” or otherwise transmit or receive all or part of a digital slide, or image of the slide, from an image server, such as the image server 850 described herein, to a review or view station, such as an imaging interface 200 as described herein, in advance of that reviewer actually requesting that particular slide image. Through such early transmission of slide images, the user/reviewer can view the images at high speed. In one embodiment, such a system would retain what might be termed an image server architecture. In an image server architecture, a view station may essentially function like a normal viewer, but may, in an embodiment, also be operating on “auto-pilot.” The view station may automatically, periodically request portions of a slide image (or periodically receive image portions) from the image server and save them locally. As will be understood, a system having this characteristic may retain significant functionality even when all of a particular slide image has not been transferred.

Viewers may, in one embodiment, operate in a framework consistent with browser design and general web server technology, which may be generally referred to as request/response. Viewers may receive (download), from an image server 850 as described herein or another server, a number of pre-streaming rules under which the viewers may operate the system. These rules may include, in various embodiments, rules regarding which slides or slide storage locations the user has access to, what type of writes (e.g. read only, read/write) may be employed, maximum download speed, maximum number of download connections allowed, encryption requirement (e.g., whether data may be required to be downloaded using SSL or similar, or whether the data may be sent unencrypted), whether data may be cached on a local machine unencrypted, and how long downloaded data may be cached. The view stations may then execute viewer requests within these rules, communicating with the image server to view images of a slide as if navigating the actual slide. In other words, the view station may become an analog of its user, but may be operable under the constraints established by the downloaded pre-streaming rules.

The system may be configured to download images from an image server to a view station at a first predetermined viewing resolution, which may be, for example, the second highest resolution available. Lower resolutions of the images may then be generated at the view station from that initially loaded resolution by operation of any of various image processing techniques or algorithms such as described with respect to the imaging apparatus 800 shown in and described with respect to FIG. 9. These lower resolution images may be generated by a flexible, decoupled scale down and compression engine. The scale down and compression engine may operate independently. This independence may allow for flexibility in techniques utilized.

Progressive compression techniques may be employed to integrate separation of an image into resolution components that may then be compressed by utilizing such techniques as quantization and entropy encoding. By decoupling the separation into resolution components from other aspects of compression, flexibility may be afforded. For example, wavelet compression techniques may inherently facilitate the generation of lower resolution images due to the orthogonality of their basis functions. The orthogonality may allow frequencies to be mixed and matched since functions are not codependent. However, the other aspects involved with doing a complete wavelet compression, such as coding, may take substantial amounts of time. Therefore, if only part of the wavelet compression, the initial wavelet decomposition, is utilized in one embodiment, the embodiment can benefit from this aspect of the compression system. After wavelet decomposition, a new image at the desired lower resolution may be reformed. This new image may then be fed into the compression engine. The compression engine may use any lossless or lossy technique, such as JPEG or PNG.

Alternatively, those actual resolutions of the images may be downloaded directly to a view station. If there is sufficient time, images at the highest resolution available may be downloaded first, and lower resolution images may be constructed therefrom, post processed, or latterly downloaded as described above.

If any part of a highest resolution image is not available before actual viewing at a view station, portions of the image at that highest resolution may be downloaded to the view station from a server, such as an image server 850 as described herein, as needed. Image portions may be identified by a user, for example, by their residence at a set of coordinates that define the plane of the slide or image thereof, or their position or location as a slide fraction (e.g., left third, central third, etc . . . ).

In one embodiment, the view station automatically downloads higher or highest resolution image portions based on which portions of the low resolution image a user is viewing. The system may automatically download high resolution image portions that are the same, near, and/or otherwise related to the low resolution portions the user is viewing. The system may download these related high resolution images to a cache, to be accessed where a user desires or automatically depending on the further viewing behavior of the user.

For example, in an embodiment, look ahead caching or look ahead buffering may be used and may employ predicative buffering of image portions based upon past user viewing and/or heuristic knowledge. In an embodiment, the look ahead caching or buffering process may be based upon predetermined heuristic knowledge, such as, for example, “a move in one direction will likely result in the next move being in the same direction, a slightly lesser possibility of the next move being in an orthogonal direction, and least likely the move will be in the opposite direction.” In another embodiment, the look ahead caching or buffering may operate based on past usage, such as by analysis of the preponderance of past data to guess next move. For example, if 75% of the user's navigational moves are left/right and 25% up/down, the system may more likely cache image portions to the left or right of the current position before it caches data up or down relative to the current position.

Where some or most review work is routinely performed with relatively low power (low resolution) images, and where some or most of the image file sizes are represented at the highest power, the portions of lower resolution(s) images corresponding to unavailable (not yet downloaded to a view station at time of user viewing) portions of a highest resolution image may be downloaded as a user views the already downloaded images. Because lower resolution image files may be smaller than higher resolution image files, lower resolution files may be downloaded faster, facilitating fast review. Only when and if the user needs to view the (not already downloaded) highest or higher resolution images may there be a more significant latency in retrieval of image data from a remote location.

The image download order, in one embodiment, may be inverted such that the lowest resolution images are downloaded to a view station first, then the next highest, and so on. Such a downloading design may lend itself particularly well to progressive image formats such as progressive jpeg or jpeg2000. In progressive formats, higher resolution images may build on the lower resolution data that has already been sent. Rather than sending an entirely new high resolution image, in one embodiment, only the coefficients that are different between the high resolution and low resolution image may need to be sent. This may result in overall less data being sent, as compared to some other alternative formats, for higher resolution images.

A feature of the system, in one embodiment, is pre-stream downloading, from an image server to a view station during slide imaging. As new portions of the digital slide become available, such as by being imaged and then stored on an image server, they may be transmitted to a view station.

The features of this design may not only complement a digital workflow, but may also, in one embodiment, augment live telepathology. Live telepathology systems may be used for consultations and may, in an embodiment, have certain functional advantages over two dimensional (2d) digital slides for some operations and may be less expensive. Pre-streaming download of the low resolution digital slide(s) of these systems may allow for much more rapid operation of such systems, since the low resolution digital slides may be viewed locally at a view station via such techniques as virtual objective or direct virtual slide review. Thus, a system in this embodiment may include both downloaded images and live telepathology functionality, such that a user may view locally-stored low resolution slide images and, where desired, view live slide images through a telepathology application.

Even with the advent of high speed networks, the methodology and architecture associated with downloading images from an image server, such as the image server 850, to view stations intended for use may facilitate fast operation of the system. By distributing images to view stations, server workload may be reduced. Even with high speed fiber optic lines connecting view stations or other clients to the server, having a number of clients simultaneously hitting the server may negatively affect performance of the system. This affect may be reduced by more efficiently spreading the bandwidth workload of the server.

In one embodiment, a component of the system is an administration interface for a server (referred to herein as the “Slide Agent Server”). The Slide Agent Server may include, for example, an image server 850 and/or a master image server 1010 as described herein, or another system or server. The Slide Agent Server may automatically, or in conjunction with input by a user, such as a case study coordinator or hospital administrator, plan and direct slide traffic. The Slide Agent Server may create a new job, which, as executed, may facilitate the diagnosis and/or review of a case by controlling one or more slide images and other information associated with the case and transporting that information to the view stations of intended diagnosticians and other viewers. The systems and processes for diagnosis and/or review at a view station may be, for example, those systems and processes described herein with respect to FIGS. 3 and 4 and throughout this application.

The job may be described and executed by a script. The script may be written in a standard software programming language such as VBscript, VBA, Javascript, XML, or any similar or suitable software programming language. Each script may be created on an individual basis, for each user or group of users of the system. A script may contain an identifier that is unique (such as a Globally Unique IDentifier (GUID)), an assigned user or users to do the job, a digital signature to verify the authenticity of the job, a text description of the job as well as what slides, cases, or other data are to be reviewed by the user. The creation of the script as well as surrounding administration data, which may include the identity of an intended user, may be editable through a secure web browser interface and may be stored on a central server, such as an image server 850 or other image server. A list of valid users, as well as the authentication information and extent of access to job information of the users, may also be modified.

Each script may then be directed to the software running on an intended user's workstation, designated proxy (a computer that is specified to act on behalf of the user's computer), or other view station. The view station may be, in one embodiment, referred to as a Slide Agent Client. Several security features may be implemented in the Slide Agent Client software program for processing the instructions of each script. For example, the program may require a user to specifically accept each downloaded script before the script is executed. Newly downloaded scripts may also be authenticated by a trusted server through Digital Signature or other methodology. The system may also require authentication of a user to download a script (e.g., before download, the user may be prompted to input his or her username and password). Secure sockets (SSL) may be used for all communications. Files written to cache may be stored in encrypted format.

The Slide Agent Client may display information to the user about the nature of the rules contained in the script to the user, e.g., what type of files, how many files, size of files to be downloaded, etc. The script may also provide a fully qualified identifier for the files to be downloaded (e.g., machine name of server, IP address of server, GUID of server, path, and filename). The script may also specify the data download order. For example, it may specify to load lowest resolutions for all files first, then next lowest resolution for all files, etc. An alternative would be to load all resolutions for a particular file and then proceed to the next specified file. Yet another variation would be to download a middle resolution for each file and then the next higher resolution for each file. Many variations on file sequence, resolutions to be downloaded, and order of resolutions may be specified.

During the download process, queue and file management capabilities may be provided to the user and/or administrator. The Slide Agent Client or Server may display current status of queue specified by the script—files to download, files downloaded, progress, estimated time left for current and total queue, etc. The user of the Slide Agent Client or Server may also be able to delete items from queue, add items from a remote list, and change order in queue of items. The user of the Slide Agent Client or Server may be able to browse basic information about each item in the queue and may be able to view a thumbnail image of each item in the queue. The user of the Slide Agent Client or Server may be able browse and change target directory of each file in the queue. The queue and file management system may also have settings for maximum cache size and warning cache size. A warning cache size may be a threshold of used cache space for which a warning is sent to the user if the threshold is exceeded. The queue and file management system may be able to delete files in cache when cache exceeds limit. This should be selectable based on date of creation, date of download, or last accessed.

Various network features may be present in the system to facilitate efficient downloading. Firstly, firewall tunneling intelligence may be implemented so that the downloads may be executed through firewalls without having to disable or otherwise impair the security provided by the firewall. To accomplish this, one technique may be to make all communication, between the user computer or proxy and the external server, occur through a request/response mechanism. Thus, information may not be pushed to the user computer or proxy without a corresponding request having been sent in advance.

For example, the user computer or proxy may periodically create a request for a new script and send it to the server. When a new script is ready, the server may then send the script as a response. If these requests and response utilize common protocols such as HTTP or HTTPS, further compatibility with firewalls may be afforded.

Another network feature that may be present is presets for each user that specify the maximum download speed at which each user or proxy may download files. These presets may allow traffic on the various networks to be managed with a great deal of efficiency and flexibility. The system may also have bandwidth prioritization features based upon application, e.g., if another user application such as a web browser is employed by the user during the download process, the user application may be given priority and the download speed may be throttled down accordingly. This concept may also be applied to CPU utilization. If a user application using any significant CPU availability is employed, it may be given priority over the downloading application to ensure that the user application runs faster or at the fastest speed possible.

The following table provides an example of a communication that may occur, in an embodiment, between a Slide Agent Client and Slide Agent Server.

| Slide Agent Client | Slide Agent Server | |
|---|---|---|
| Request | Response | Actions |
| GUID and Desc | JobID(s) for GUID | Slide Agent Server: Add |
| | | as new workstation, |
| | | update existing or no |
| | | change |
| | | Slide Agent Client: |
| | | process JobID(s) and |
| | | make individual requests |
| | | for each JobID |
| JobID | Filename list for JobID | Slide Agent Server: |
| | | Create list of filenames for |
| | | JobID with checksum to |
| | | return to agent |
| | | Slide Agent Client: Add |
| | | files for JobID to queue |
| Filename | File | Slide Agent Server: |
| | | Retrieve file from disk and |
| | | return |
| | | Slide Agent Client: Save |
| | | file to cache available for |
| | | MedMicroscopy Viewer |

An example file list may, in one embodiment, look like the following list:

/folder2/Filename1.tif;checksum

/folder2/Filename2.tif;checksum

/folder2/Filename3.tif;checksum

/folder3/Filename2.tif;checksum

Various embodiments of the systems and methods discussed herein may generate on a complete imaged-enhanced patient-facing diagnostic report on a physician or diagnostician desktop.

Various embodiments may ensure consistency and remove bias because all users who analyze the specimen may view the same image, whereas, remote users who utilize glass slides may use different slide sets.

Various embodiments may also speed remote diagnosis and cause remote diagnosis to be more cost effective because images may be sent quickly over a network, whereas, with slide review, a separate set of slides may typically be created and mailed to the remote reviewer.

Various embodiments of the systems and methods discussed herein may permit users to view multiple slides simultaneously and speed the image review process. In addition, by utilizing embodiments of the systems discussed herein, slides may avoid damage because they need not be sent to every reviewer.

Various embodiments of the systems and methods discussed herein may be customized with respect to various medical disciplines, such as histology, toxicology, cytology, and anatomical pathology, and may be employed with respect to various specimen types, such as tissue microarrays. With respect to tissue microarrays, various embodiments of the system and methods may be customizable such that individual specimens within a microarray may be presented in grid format by specifying the row and column numbers of the specimens. With regard to toxicology applications, in which many images are quickly reviewed to determine whether disease or other conditions exist, various embodiments of the systems and methods discussed herein may be utilized to display numerous images in a single view to expedite that process.

Various embodiments may relate to an electronic system and method for peer review in toxicity and risk assessment studies. Various embodiments may relate to a system and method for evaluating pathology image data for use in establishing an automated peer review procedure and, more particularly, to a method and system for performing peer review on one or more image forms, including virtual microscope slides.

In various embodiments, peer review procedures may be carried out in connection with toxicity and risk assessment studies performed to evaluate the efficacy of new drugs or pharmaceutical preparations. The effective and safe administration of pharmaceutical products to patients, particularly in the context of determining an appropriate drug therapy following any clinical diagnosis, has become what may be considered an evermore complex and challenging task for the modern healthcare professional. In particular, as clinical diagnoses and medical treatment become more sophisticated, the number of patients, and indeed the number of illnesses or clinical indications, may become proportionately larger, particularly in the case of expanded aged population growth. Further, as clinical indications (e.g., genetic variability in treatment guidelines) become better understood, a growing number of drugs and/or pharmaceuticals may be becoming available for treatment of increasingly specific medical conditions.

In order to achieve approval for treatment of particular clinical indications, a new drug and/or pharmaceutical may, in certain circumstances, have to demonstrate not only its efficacy, but also the risk levels associated with its pharmacotherapy regime. In the United States, the Food and Drug Administration (FDA) regulates the investigation of drugs. Pharmacologic and toxicologic data from animal studies may have to be submitted to the FDA as part of an application for an investigational new drug (IND). If these data demonstrate that the drug is sufficiently safe and effective, human (clinical) studies may be conducted in three phases; data from these studies may be submitted as part of a new drug application (NDA).

The pharmacokinetic, pharmacodynamic, and toxicologic properties of a drug may have to be evaluated and documented in animals according to FDA regulations, in accord with good laboratory practices, or GLP, standards, before study in humans. Two main assumptions may be made: The effects of chemicals in appropriately selected laboratory animals apply to humans; and the use of high doses in these animals is a necessary and valid method for discovering possible toxicity in humans. High doses may be necessary in certain circumstances because of the relatively small number of animals used and the need to detect low-incidence toxic responses. The safety of a drug may be determined by studying the acute, subchronic, and chronic toxicity of the drug in several animal species.

Chronic toxicity studies, conducted in at least two species (including one nonrodent), may last the lifetime of the animal (up to 2 years in a rodent or longer in a nonrodent), but the duration may depend on the intended duration of drug administration to humans. Three dose levels may be used, and may vary from a nontoxic low-level dose to a dose that is higher than the expected therapeutic dose and that is toxic when given long-term. Physical examinations and laboratory tests may be performed at intervals throughout the period of drug administration. Some animals may be killed periodically for gross and histologic examination. On the basis of these results, investigators may determine which organs are affected and whether the drug is potentially carcinogenic.

Bioassays may be taken from the organs under examination and evaluated for clinical pathology and histopathology parameters. As part of the analysis procedure, a peer review may be performed on the initial results in order to resolve ambiguities that may arise because of the arguably subjective nature of these pathology and histopathology parameters. One pathologist may interpret a marginal animal stain (a bioassay slide) into one category, while another pathologist may have an entirely different interpretation.

Peer review of bioassay slides may be desirable in certain circumstances. Peer review may allow for treatment and removal of the major sources of ambiguity and may promote a higher quality result. An automated peer review system may also be desirable in certain circumstances, such as where the primary researcher and the peer reviewer reside at different locations, because it may allow for a consistent analysis and review procedure, may provide for a determinable source of investigating pathologist annotations, and may support an opportunity for the primary and consulting reviewer to harmonize their findings without undue consultation time.

Such an automated peer review system may be able to direct the conduct of a toxicological study in a manner approved by good laboratory practices. It may, as well, support the use of digital bioassay slides or other images of specimens of the type currently utilized in telepathology applications. The use of digital bioassay slides may significantly increase a pathologist's throughput, in certain circumstances, by minimizing slide handling times, as well as reducing slide degradation and/or damage through reduced handling. An automated digital analysis and annotation system may be able to associate the findings and/or annotations of a reviewer directly with a corresponding slide by application of associative or relational database identification techniques. The study results may become one set of related files, images and annotations, which may be easily maintained, easily retrievable and unified.

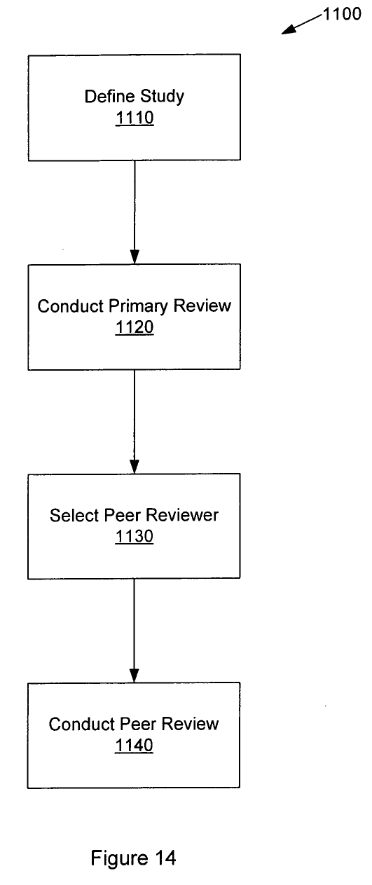

FIG. 14 illustrates an embodiment of a basic flow of a toxicology and risk assessment study process 1100, including an initial diagnosis and peer review of images of slides. The study process 1100 may be performed by way of the image system 799 of FIG. 9 in an embodiment. At 1110, the study may be defined and may include, for example, four study groups, such as a control group, low dose group, medium dose group, and high dose group. Each group may include, for example, 20 animals of which 10 are male and 10 are female. Depending on the animal, there may be, for example, 50-55 tissues or other specimens per animal, arranged on roughly 30 slides. Images of the slides may be captured and processed by a system and method described herein, such as shown and described with respect to FIGS. 2, 8 and/or 9. A site administrator or other user may define the study at 1110, such as by access the image system 799 of FIG. 9, identifying slide images stored thereon, and inputting study parameters (such as described herein) to be associated with the slide images by a processor of the image system 799.

A primary reviewer, such as an original diagnoser, may, at 1120, review the entire set of slides, either the actual slides or the images of the slides or both, and record his or her findings in a data capture system (e.g., Xybion, Pathdata, an image system 799 or component thereof, etc.). The primary reviewer may employ an image interface 200 and/or a digital microscopy workstation 901 such as described herein, for example, to review the images of the slides and associated information regarding the study, and to record the findings. In an embodiment, the recorded findings may be transmitted to the image server 850 of the image system 799 by way of a network, such as the network 991 of FIG. 11.

Following primary review, a pathologist or other reviewer, such as one from another geographic site, may be selected at 1130 to perform a peer review at 1140. The peer reviewer may be selected at 1130 by a peer organization, such as a research organization conducting the study, by an administrator, primary reviewer, other user, or automatically, such as automatically by the image system 799. The automated function may be defined by an administrator, for example, who may input rules for peer review to be executed by the image system 799, or may be performed otherwise as described herein. The peer reviewer may be selected where pathologist or reviewing experience matches particular study needs. Where the actual slides will be reviewed, the peer review may be conducted at 1140 at the primary site, where the slides are located, to minimize the risk of damaging the glass slides by transporting them, to provide security (e.g. GLP compliance with chain of custody), and to facilitate face-to-face interaction between primary and peer reviewers. Alternatively, the peer review may be conducted at another site, such as when particular expertise is needed from a remotely located reviewer, or where only images of the slides will be reviewed.

Peer review at 1140 may cover a percentage of slides or other scope of review, which may be set, in an embodiment, at 1130. As an example of a scope of review, 25% of all slides and/or images of slides may be peer reviewed. A full read, or a read of all the slides, may be performed on the slides and/or images of the high dose animals and on the controls. This full read may determine the key organs (e.g., liver) affected by the compound for which the study is being conducted. The slides and/or images of the target organs may then be reviewed at 1140 in all medium and low dose animals to assess toxicity levels. In an embodiment, if an effect of the compound is not present in medium-dose slides, the low-dose slides may be skipped. A grade or diagnosis may be assigned to each organ. Non-affected organs may not be screened in the medium and low dose groups, so the total number of tissues or other specimens that are read may be significantly less than the number the primary reviewer read.

Selection of actual slides for peer review may occur when, if applicable, the peer reviewer performs the review at the primary site. Slides may be selected for review manually, randomly, by interval, based on mortality criteria, and/or based on other criteria. In a digital environment such as described with respect to the image system 799 of FIG. 9 or otherwise herein, the slides may need to be prepared for review ahead of time, such as described herein (unless all slides have already been imaged, processed, and stored such as described herein).

In one embodiment, the peer reviewer writes down his or her findings (hardcopy). The peer and the primary reviewers may then harmonize findings. Based on the harmonization, the primary reviewer may update the findings in the data capture system, such as an image server 850 or other system. These findings may then be locked and the peer notes may be destroyed. If the peer and primary reviewers cannot agree on a finding, then a third reviewer may be invoked to resolve the impasse.

In another embodiment, the peer reviewer, at 1140, employs the QA/QC system 500 of FIG. 4 through a node such as an image interface 200 and/or a digital microscopy station 901 as described herein, to review images of slides and to record findings. The peer reviewer, in this embodiment, does not know some specifics of the diagnosis of the primary reviewer, and records his or her findings on the system, such as on an image server 850 or 1020 as described herein. As described with respect to the QA/QC system 500, the findings of the peer and primary reviewers may be analyzed automatically by the system or by a third party to determine discrepancies.

The timeframe for a peer review may be a few days. During peer review, a pathologist or other reviewer may be expected, in certain circumstances, to read the slides or images of slides of about 4 to 10 animals per day. This may be done at an increased workload of 5 hours/day or more (as opposed to 4 or fewer microscope hours/day, which may be the workload under normal job conditions, for example).

There may be only one peer reviewer per study. In an embodiment, a third pathologist or other reviewer may conduct a review for cases or studies where there is disagreement on findings. In another embodiment, a peer review may be conducted by multiple pathologists or other reviewers who may respond as a group to discrepancies between the findings of a primary reviewer and peer reviewer.

Different reviewers may have different styles in reviewing slides or slide images in a case or study. In one embodiment, this style may be designated by a user. One style may include the selection of a subset of animals in the high and control groups for which slides or slide images will be reviewed at 1140. For example, a reviewer may want to review the 1st, 5th, 10th, 15th, 20th, etc., slides or slide images of the high and control groups, or some other interval. Another style may include reviewing slides or slide images at 1140 of the control group first, or alternatively the high dose group first. Another style may include performing the read or review of slides or slide images at 1140 horizontally (e.g., slides of all animals, a specific tissue, or animal by animal (all tissues, by animal)).

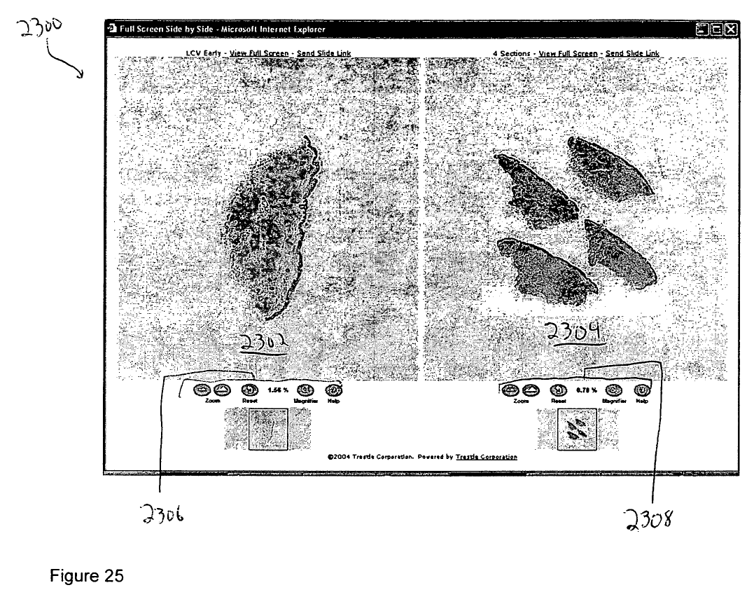

For example, in an embodiment, a peer reviewer or other user may employ an image interface 200 or digital microscopy station 901, as described herein, to view slide images or references thereto in a displayed grid or other graph that provides a breakdown of images by multiple criteria. For example, the grid may have on one axis, a listing of images of lesions categorized by animal group or dosage group, and on the other axis a number of incidents of necrosis, mitosis or one or more other conditions identified in the lesions. A user may be able to mouse-click or otherwise actuate any of the cells in the grid display to access the images to which the cell refers, and may view two or more images simultaneously, such as described with respect to the compare option display 2300 of FIG. 25 or the image compare display 2900 of FIG. 31, for example. Other examples of grid criteria are organ type by animal identification and pathology lesion by incidence/severity thereof.

The grid may be categorized by a primary reviewer or another user, and the system may allow for dynamic creation and modification of the grid by the user. A user may create a grid by marking or pre-classifying slide images to provide for a more structured future review of the images by the user or another user or users.

Another style may include a scan or viewing method for reviewing images of specimens-serpentine, raster, top-to-bottom, right-to-left, etc. The style may be programmed into a viewer application, such as an image interface 200 or digital microscopy station 901, such that different patterns may be automatically tracked, so that a pathologist or other reviewer does not have to manually prompt the capturing of the image portions of the digital slide. The pathologist or other reviewer may simply tap a key on an input device of the image interface 200, for example, to go to next image portion or field, or the system may automatically go to the next image portion or field after a predetermined amount of time.

In one embodiment, the stored data related to or associated with each image of a slide may include digital images of tissues or other specimens for each animal in the study being reviewed. The data may also include primary diagnoses and/or other primary review findings of the original diagnostician or other primary reviewer. The primary review findings may be extracted from a data capture system (e.g., Xybion, Pathdata, or an image server 850 or component thereof. Final (harmonized) findings may also be entered into the data capture system. The data may also include peer findings, which may be discarded after harmonization with the primary findings, or may be kept for archival or educational purposes, or for other purposes. The data may also include one or more parameters of the study, such as the sex of the animal from which the specimen was taken, dose or dosage group or control group, tissue or other specimen type, type of study, type of species.

In one embodiment, a peer or primary reviewer employs a viewer, such as an image interface 200 or digital microscopy station 901 such as described herein, to view images of slides side-by-side, such as described with respect to 450 of the diagnostic system 400 of FIG. 3. Side-by-side or other simultaneous viewing may be useful or especially important when changes or differences between the images are subtle. For example, comparison of certain dosage group and control group images, or certain images from one dosage group and a second dosage group, of tissues side-by-side may facilitate recognition of subtle differences.

In one embodiment, the system may provide for the quantification of slide specimens, and thus inclusion of quantitative information with the study data. Thus, cells, for example, of a specimen on the slide or slide images could be characterized (possibly not diagnosed at that time) to assist a pathologist or other reviewer with grading or diagnosing tissues (e.g., hepatocyte hypertrophy). Pathologist or other reviewer sensitivity may be detection of about 30% change, for example.

In one embodiment, the system may provide or facilitate the comparison of a study with other studies by retrieving or otherwise accessing the other studies. The studies may be stored on a server, such as an image server 850 as described herein.

In one embodiment, the system provides for blind review, or peer review without knowledge of one or more fields or parameters of a study, such as dosage group, and/or one or more other portions of the study data. Thus, for example, the system may not allow access by a peer reviewer to one or more parameters of study data associated with a slide image. Blind review may be used where changes are subtle, such as where the differences between the specimens of two or more of the dosage groups and control groups are subtle. Blind peer review may prompted to be implemented by the primary reviewer, who may select a blind peer review option, or by the peer reviewer, who may decide whether or not to review blind. The implementation of the blind review may designate the one or more parameters that are to be inaccessible by the peer reviewer during the peer review. The system in this embodiment may employ blind review by incorporating functionality of the QA/QC system 500 as shown in and described with respect to FIG. 4.

In one embodiment, the system may provide for the inclusion, during peer and/or primary review, of study data that are annotations, such as text notes and/or markings on an image such as lines, arrows, sticky notes, etc. Thus, for example, a reviewer may input, such as through an image interface 200 or digital microscopy station 901, one or more annotations to be associated with one or more images of a slide. Each annotation may, in an embodiment, be associated with a point or portion of the image, for example, and may be added to, or referenced on, the image at that point or portion, such as by superimposition or hyperlink.

In one embodiment, gross specimen images or portions thereof may be integrated. For example, captured images of portions of a slide and specimen thereon may be automatically assembled by the system, such as by stitching or other means.

A system that provides for review of images of specimens at a remote site, such as at an image interface 200 or digital microscopy workstation 901 as described herein, may, in certain circumstances, reduce reviewer eyestrain and skeletal strain, may provide better ergonomics to a reviewer, and may reduce reviewing error due to fatigue. Such a system may, in certain circumstances, also reduce travel costs, provide better access to archival data such as data from similar studies, and may facilitate better grading or diagnosing of the specimens due to easier slide comparison.

In one embodiment, a system employs use cases, which enable system functions and which may be employed by executing scripts. The use cases may be employed by associated actors, such as diagnosticians, administrators, computers, or other system users. Following are examples of use cases and their associated actors. Each use case example may refer to the actors' definitions located in this section. The association between the actor and the use case will be described in each individual use case example.

The actors of the use cases may correspond to the users of the system. Examples of actions of these users with regard to the system are described below. The actors may not be identical to the users, because the actors may, in an embodiment, describe user roles, and a single user type may fill more than one role in the system, and a role may be filled by more than one user type. An actor may, in an embodiment be one or more computers that have been prompted by a user or users to automatically and periodically execute the use cases.

Each site, such as a hospital or research clinic or other site having an image system 799 of FIG. 9 or portion thereof, for example, may have, in an embodiment, a site administrator. At a primary facility, such as a facility in which the actual slides and specimens are located, the site administrator there may request a peer review, such as through the network 991 of FIG. 11. At a peer facility, such as a facility having an image interface 200 or otherwise where peer review of the specimens occurs, the site administrator there may assign peer review to a reviewer. A primary reviewer, such as a diagnostician at the primary facility, may, such as at 1120 of FIG. 14 described above, perform or be involved in initial review of the entire study, including requesting or performing data capture. The primary reviewer may, in an embodiment, work with the peer reviewer to harmonize findings. The peer reviewer, such as a diagnostician located at the peer facility, may performs peer review on the study, and may work with the primary reviewer to harmonize findings. In an embodiment, the primary reviewer and peer reviewer may employ the diagnostic system 400 of FIG. 3 and the QA/QC system 500 of FIG. 4, respectively, in performing their reviews. The primary and peer reviewers may access these systems and employ use cases, for example, through a server, such as an image server 850 as described herein, by way of image interface 200 and/or a digital microscopy station 901 as described herein.

In one embodiment, a system administrator, such as a study supervisor or a computer technician manages the transfer of images, either electronically such as describe herein or by hard media, between the primary and peer reviewers.

Following are examples of use case embodiments that may be included in and employed, such as in succession or otherwise, in the system by one or more peer reviewers or primary reviewers or other user. An actor, which may be one or more users, may employ the log in use case to log in to the system by entering authentication information (such as user name and password) to use the system or an application thereof. In one embodiment, no guest usage of the system is allowed.

An actor such as a primary reviewer may employ the define study use case to define a study. The defined study may include study information designated for review by a peer reviewer.

An actor may employ the peer review request use case to enter a peer review request. The actor employing the peer review request use case may be a primary reviewer who completes a review of the study and notifies a site or system administrator, who may then request peer review from another site or facility. The peer site or system administrator may assign the peer review to a pathologist or other reviewer.

An actor such as a peer reviewer may employ a peer review use case for peer review. The peer review may be performed on one or more cases or studies assigned to the actor. The peer review may include the performing of functions necessary to determine a diagnosis. The functions may include any or all of the following: slide or image review, slide or image comparison, autoscan or automatic imaging or viewing of the specimen in a predetermined pattern, and quantification of the specimens.

An actor such as a peer reviewer may employ the harmonization/collaboration use case for harmonization/collaboration with respect to the diagnosis and peer review. The harmonization/collaboration may include interactive review of the case to resolve discrepancies between results of the primary reviewer and peer reviewer. In other embodiments, the harmonization/collaboration may be completed by a third reviewer or automatically, such as described with respect to the QA/QC system 500 of FIG. 4.

An actor may employ the peer review status use case for peer review status management. The peer review status management may include notifying a peer reviewer of requests for peer review and of the status of ongoing reviews. The peer review status management may also include notifying a primary reviewer of the peer review status and allowing the primary reviewer to close the review.

An actor such as a study supervisor or computer technician may employ the administration use case for administrative purposes. The administrative purposes may include defining a site in which the study review will be conducted. The site may be, for example, a hospital, server such as an image server 850, and/or an image interface 200 as described herein. The administrative purposes may also include defining specific users who are granted access to the site for the study, and assigning specific access rights, such as for an administrator or reviewer.

In an embodiment, a system, such as, for example, the Trestle Peer Review application, allows distributed, digital peer review. Independent of time zone or location, pathologists may employ the system to execute peer review in a networked, digital fashion. Such a system may facilitate time and resource efficiency as well as opening a multitude of value added digital analysis applications. In one embodiment, the image system 799 of FIG. 9 comprises this system.

The system architecture, such as for the Trestle Peer Review application in an embodiment, may be highly flexible. In an embodiment, the system is a distributed imaging application, and thus its physical architecture may vary with implementation.

The system may employ a use case to perform a system function. Examples of such functions are as follows:

| ID | Function | Description |
|---|---|---|
| 1 | Log In | Enter authentication information (such |
| | | as user name and password) to use |
| | | the application. No guest usage of the |
| | | site is allowed. |
| 2 | Home Page | Main access to product functions, |
| | | overview of workload. |
| 3 | Define Study | Defines characteristics of the study |
| | (Primary | (compound, dosages, animal) |
| | Reviewer/Site | |
| | Administrator) | |
| 4 | View/Edit Study | Shows findings and thumbnails |
| | (Primary/Peer | associated with study |
| | Reviewer) | |
| 5 | Peer Review | Allows administrator to request a peer |
| | Request (Primary | reviewer from another site. |
| | Site | |
| | Administrator) | |
| 6 | Peer Review | Allows administrator to request a peer |
| | Assignment (Peer | reviewer from another site. |
| | Site | |
| | Administrator) | |
| 7 | Imaging Request | Allows Peer Reviewer to designate |
| | | which slides to image. |
| 8 | Image Import | Imports images (file names) into study. |
| | (System | (Requires study) |
| | Administrator) | |
| 9 | Slide Search | Criteria include study, compound, |
| | | animal, organ, sex, dosage, date |
| | | range |
| 10 | Slide Review | (includes Auto-Scan) |
| 11 | Slide Compare | Side-by-side comparison of two |
| | | selected slides. |
| 12 | Enter Findings | General to slide or tissue/location |
| | (Peer Reviewer) | specific annotations |
| 13 | Quantify | Standard tissue characterization |
| | | (nuclei, vacuoles, etc.) |
| 14 | Collaborate | Interactive review of a slide between |
| | | reviewers |
| 15 | Resolve Findings | Dispensation of findings. Primary |
| | (Primary | enters harmonized results into data |
| | Reviewer) | capture system (eg. Xybion, Pathdata, |
| | | etc) and closes review. |
| 16 | Change Review | Allows administrators and reviewers to |
| | Status | update review status based on their |
| | | workflow. |
| 17 | User/Site | Defines roles and site associations of |
| | Administration | personnel associated with review |
| | (System/Site | process. |
| | Administrator) | |
| 18 | Reporting | Provides formatted reports for various |
| | | data elements in the system such as |
| | | study, administration, audit trail, and |
| | | usage data |

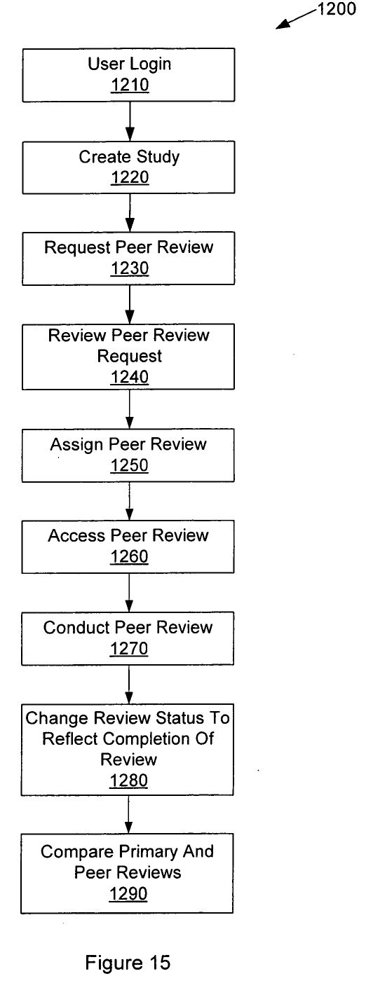

FIG. 15 illustrates an embodiment of a system workflow process 1200, including examples of the actual forms that implement the use cases such as those described herein. At 1210, any valid user may log in to the system, such as by way of an image interface 200 as described herein, and may be presented a system home page. Where the user is a primary reviewer, the user may, at 1220, from the home page, create a study. The user may define the study and import findings from a data capture system (e.g., Xybion, Pathdata, or other system that may, in an embodiment, be included in the image system 799 of FIG. 9). The user may perform the primary review and then, at 1230, notify a primary site administrator or other user via e-mail (or other electronic notification such as instant message) that the primary review is completed and the study is ready for peer review. At 1240, the primary site administrator or other user may access the system, such as by logging in or otherwise accessing the system and being presented a home page, for example, and review the peer review request transmitted by the user at 1230. At 1250, the primary site administrator or other user may assign the peer review to one or more users based upon, for example, availability, area of specialty, prior study involvement, and/or other factors. Slide images and associate data may be transmitted to a node, such as an image interface 200 described herein, that will be employed by the peer reviewer in advance of peer review, such as described with respect to the image system 799 of FIG. 9 or otherwise herein.

In one embodiment, the system, at 1230, may be configured in an automatic dispatch mode such that requests from the primary reviewer automatically generate an email request (or similar) to a peer site administrator. The peer site administrator may manage transmission of the study to one or more users and an associated notification to the one or more users.

At 1260, a peer reviewer or other user may access the study, such as by logging into the system by way of an imaging interface 200 or other node and accessing the images and associated information related to the study. The user may access the study, in an embodiment, by logging into the system and receiving a home page. The home page may provide a worklist that includes the study. The user may access the study to see the study's properties and may request images and other information, such as from the system administrator, related to the study. The request may prompt the system to import and transfer the images to the image interface 200 or other node.

The peer reviewer or other user may, at 1270, conduct a peer review of the study. The peer review may at 1270 may include, for example, slide review, autoscanning or otherwise requesting imaging or viewing of the slide or slides automatically, slide comparison, entry of findings and/or annotations related to the study, a slide search, such as for slides in the case or slides in other related cases, and specimen quantification such as described above. At 1280, the peer reviewer or other user may change the review status to reflect completion of the review or may otherwise identify the peer review as completed. Such identification may, in an embodiment, prompt the system to notify the primary reviewer and/or another user or users that the peer review is completed. Such identification may also transmit the peer review findings to the notified user or users for review or may otherwise provide access to the peer review findings, such as by way of a link on the home page of the notified user or users.

At 1290, the primary and peer reviews may be compared, such as by the primary and peer reviewer findings and/or other study data together, by an administrator, or automatically by the system. For example, in one embodiment, the primary and peer reviewers may together log in to the system, such as described, and view the study and collaborate to harmonize the findings. In another embodiment, the primary reviewer may login in and resolve his or her findings based upon the peer review findings, and may then change the review status to reflect completion of the study or may otherwise identify the study as completed.

The system may designate review statuses, such as stated above, to designate the progress of the peer review. Such statuses may include, for example, one or more of the following:

Ready for Peer Review (Primary Reviewer)

Peer Review Requested (Primary Site Administrator)

Peer Assigned (Peer Site Administrator)

Peer Review Completed (Peer Reviewer)

Study Completed (Primary Reviewer)

In one embodiment, a system administrator/site administrator may manage one or more portions of the study and peer review, and may log in or otherwise access the system, such as via a home page providing user/site administration functionality.

In one embodiment, a primary or peer reviewer or another user may access images and other information related to a study stored on a database of the system. The database may be, in various embodiments, locally or remotely stored. The user may, in an embodiment, access a study repository, which may be defined for each user and/or may be shared by one or more users in an organization or workgroup, for example. More than one study repository may be accessible by a user or users, such as the users of a large organization.

The system may provide standard functionality that may be employed in a standard windows dialog on an image interface 200 as described herein or another computer. Such functions may include, for example, a page setup, print preview, print function that may be employed to print various objects such as reports, images, current screen, etc., log out function that closes the current session and returns to the log in screen, a log in function that launches the login page that may provide an entry point for the system application, a send to function that sends a currently selected object (image, report, finding, etc.) to a designated recipient via email or similar electronic messaging system, and an exit function that closes the application. The exit function may include a prompt to request confirmation of the exit (e.g., “are you sure that you want to exit Peer Review?” Yes=close; No=cancel).

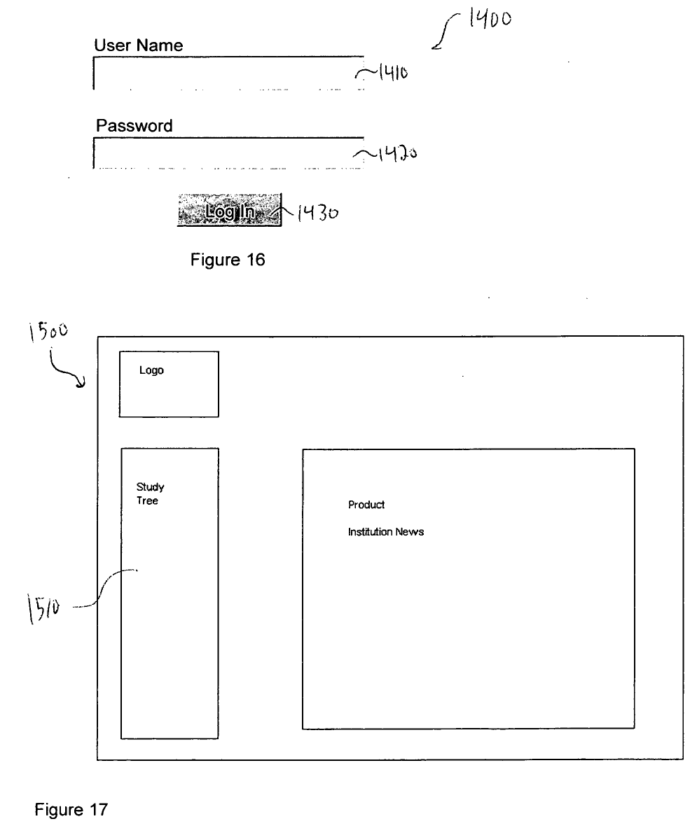

Regarding the log in function, the system may provide a log in screen, such as the log in screen 1400 shown in the embodiment of FIG. 16. The user may employ the log in screen on an image interface 200 as described herein or another node. The user may enter user name and password in the user name area 1410 and password area 1420, respectively, and select the log in button 1430 to enter the system. The system may verify the identity and accept or reject the user. If the log in fails, the system may display a message such as “Log in failed,” and provide an “OK” or other button a user may press to return to the login page. In one embodiment, the system may only allow a predefined number of login attempts and bar the user from entering the system when the user exceeds that number.

In an embodiment, the system can store all log on activity (each failed and successful login attempt) for production in an audit trail. All available information regarding the user may be stored, including but not limited to IP address, subnet, machine name for user computer, time, and operating system on the user's computer.

In an embodiment, the identity of the user, such as determined by logging in, determines what data may be accessed at the logged in node and what the workflow may be provided, requested, or employable at the node. In one embodiment, the system does not allow non-identified, or “guest,” usage of the system.

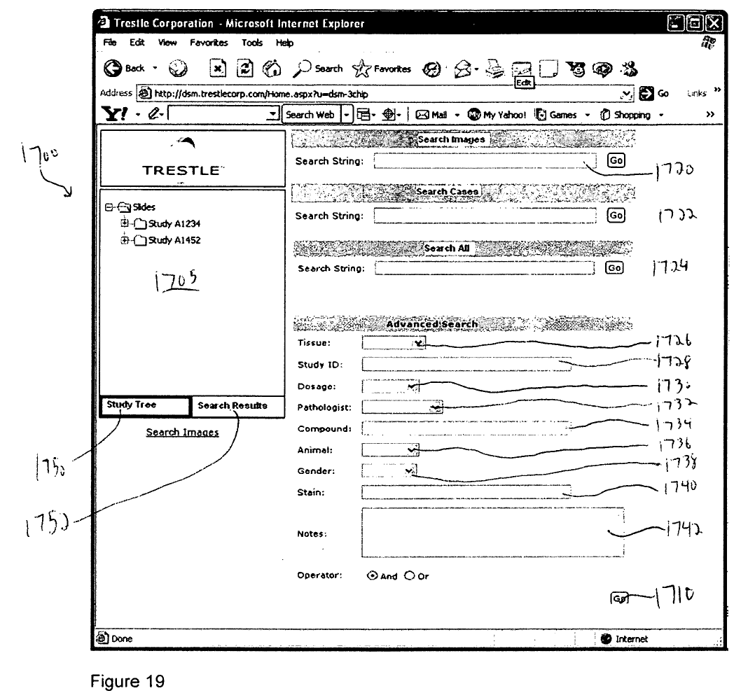

After the user logs in, the system may display a home page, which may be the opening page of the system. FIG. 17 illustrates a home page display 1500, in accordance with one embodiment. The home page display 1500 may include a study tree area 1510, which may contain the studies to which the user has access, such as the study tree display 1705 shown in FIG. 19 below. The studies may be arranged by a user definable order, such as numerical or alphabetical order, for example. In this embodiment, the home page display 1500 does not have a study selected by the user to be reviewed or otherwise considered.

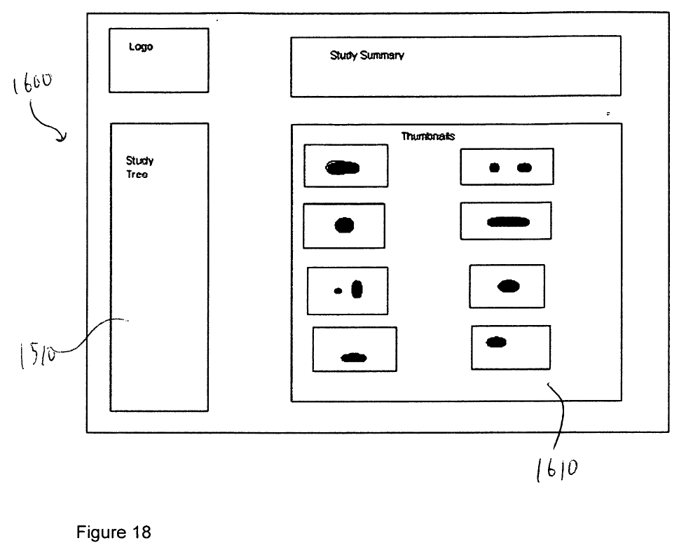

FIG. 18 illustrates another embodiment of a home page display 1600, in which the home page display 1600 includes a study display 1610 selected by the user for review or other consideration.

Other functionality of the system may include edit menu options or functions for manipulating text and other objects (e.g. images). Such functions may include one or more of the following, for example: a cut function, which may remove a currently selected object or text and place it on the system clipboard; copy function, which may copy a currently selected object or text and places it on the system clipboard; paste function, which may paste contents from a clipboard to a currently selected area on the use screen; clear function, which may clear the clipboard; and a find function, which may allow a search of the contents of a current screen, e.g. the home page display 1600, for a keyword or words.

A user may also employ various viewing menus options or functions, which may control what is displayed on the screen of an image interface 200 or other node, for example, the user is using. Such functions may include a thumbnails function that may toggle a display of thumbnails of a specimen image or images; a summary function that may toggle the display of a study summary; and/or a toolbars function that may toggle a display of various application toolbars.

The system may also provide a tools menu that may provide options a user may employ. For example, one tool may be an image retrieval search tool, in which a user may request and receive images and/or cases having certain available image metadata and/or other stored information, including, for example, image metadata related to one or more of the following: study (defaults to currently selected); compound; dosage; animal; sex; organ; and other user-defined fields.

The application search structure of the system may be based on a database structure for the database in which the information is stored. The search may, in an embodiment, be restricted to studies and data fields to which the user has access.

FIG. 19 illustrates an embodiment of a retrieval search tool display 1700 for searching and retrieving image and study data information, in accordance with an embodiment. The user may, via an image interface 200 as described herein, for example, enter search criteria for searching slide images and study data information and then press the “Go” button 1710 to start the search. The search criteria may include one or more of criteria for searching images, cases or studies, all information on the network and/or system, tissue, study ID, dosage, pathologist, compound, animal, gender, stain, and notes. These criteria may be entered into the retrieval search tool display 1700 in the areas 1720 through 1742, respectively. The system may search its stored information, such as that on one or more image servers 850 and/or 1020 accessible by way of the network 991 of FIG. 11 or network 1000 of FIG. 13 in various embodiments, and may return all objects (images and/or cases), or a list thereof, matching the criteria. Searches may, in an embodiment, be restricted to the current study or allowed across all stored images.

In an embodiment, search results may be saved to a search results tree. Queries and search results may also be saved for later use. In an embodiment, the search is restricted to studies and data fields to which the user has access.

In an embodiment, the default study tree display, such as the study tree display 1705 of FIG. 19, may be replaced with a search results tree. The search results tree may operate in at least three different modes: images only, simple results tree, and dynamic tree. The mode may be selected by the user.

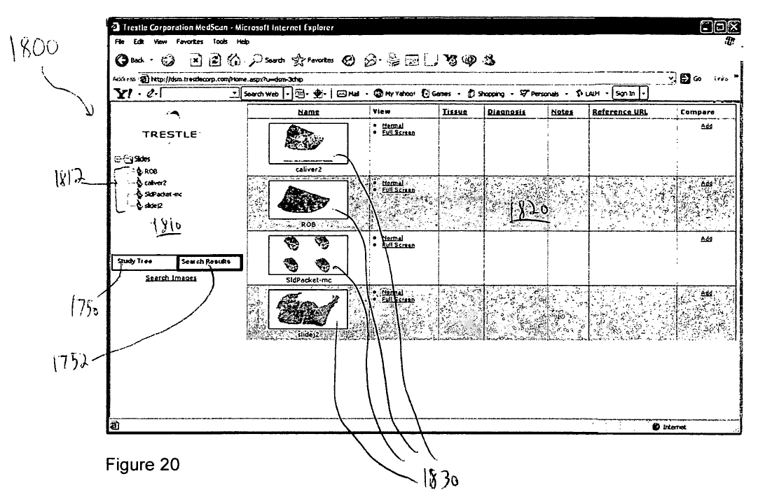

FIG. 20 illustrates an embodiment of an images only results display 1800 of search results, showing an images only search results tree 1810 and a corresponding image display 1820. The search results tree 1810 may not distinguish the study origin of an image but may simply provide an image list 1812 of all the images of the search results together, such as under the name “slides” in the search results tree 1810, for example. This function may serve to allow rapid browsing of images in the images only display 1820 when it is not necessary to know the exact study origin. The images display 1820 may, in an embodiment, also display thumbnails, such as one or more thumbnails 1830.

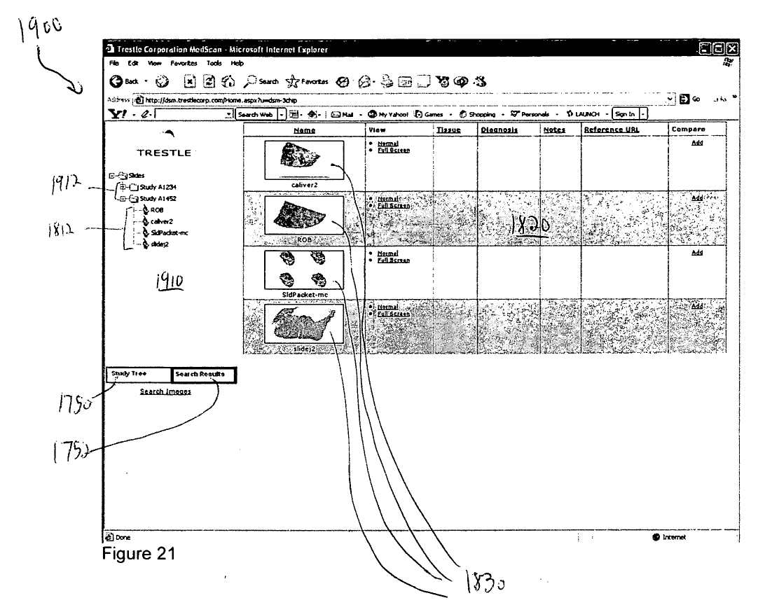

FIG. 21 illustrates an embodiment of a simple results display 1900 of search results, including a simple search results tree display 1910. The simple search results tree display 1910 may include study listings 1912 with positive search results, which may mean the study itself is a positive search result or the study contains images with positive search results. Images that are part of these studies may also be displayed underneath (a lower level in the tree) the respective study.

In one embodiment, images that are not positive search results but are part of a study with positive search results may be displayed in an alternate color, line style, or similar visual mechanism to denote that they are not positive search results.

In one embodiment, if the user prefers, the images not matching the search criteria may not be displayed.

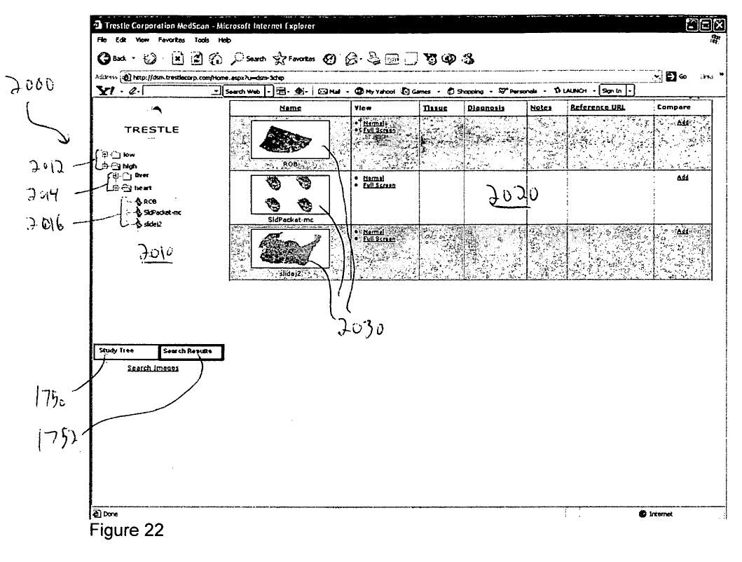

FIG. 22 illustrates an embodiment of a dynamic results display 2000 of search results. The system may allow the user to dynamically create the tree hierarchy of the dynamic tree display 2010 in a top down fashion. For example, the user may select the first level of the tree from a list of available metadata fields, such as “dose,” for example. The selected metadata field may then become the top tree level 2012 or tree level node. The tree may then sort objects based upon alphabetical or similar order to create the top level entries. The system may then populate the top level entries with slides among the positive search results having specimens subject to such doses. If dosage possibilities were low, medium, high, and control but the positive search results only contained objects from low and high, then the top level may display only two entries, low and high.

This process may be repeated for the next level (second level) of the tree, or second tree level 2014 or second tree node. The list of available metadata fields may eliminate the previously selected field from the higher level as a possible selection. In this example, dosage may be eliminated as a choice. The user may select another metadata field such as “organ,” for example. The second level for each top level may then be populated with metadata field values for “organ” which exist in the search results for that top level. For example, if the top level, low dose entry included images only from kidneys and lungs, then the second level nodes for low dose would be populated with kidneys and lungs. If the other top level entry, high dose, contained images only from livers and hearts, then the second level entries for high dose may be populated with liver and heart images. This process may be repeated up to available metadata fields or until the user desires to stop this subclassing process. In the embodiment shown, image listings 2016 are listed under “heart” entry of the second tree level 2014, which is listed under the “high” dosage entry of the top tree level 2012.

For all three type of search results trees, the user may toggle back and forth between the search results tree and the study tree. This may be accomplished by the user selecting an option on the screen such as a button or buttons near the tree. For example, one button may be selected to display the study tree, and one or more other buttons may be selected to display search results (depending on the number of searches desired to be displayed).

For example, as shown in the embodiments of FIGS. 19-22, there may be two buttons, a study tree selection button 1750 and a search results selection button 1752 that may be employed to toggle the display. In one embodiment, the actively or currently displayed selection may be denoted by having a thicker border around the button. The other tree may be displayed as a button with thinner borders. If the user selects the study tree selection button 1750 then the system may revert back to displaying the original study tree such that the study tree selection button 1750 may have the thick border and the search results selection button 1752 button may have the thin border.

In another embodiment, a tools menu, which may be included in one or more of the displays of FIGS. 17-22 provide a collaboration option a user or users may employ to collaborate on a study. Employing this option may prompt the system to launch an interactive session between the peer reviewer and the primary reviewer of a study. Functionality associated with the collaboration may include retrieval and editing of findings and annotations and whiteboarding of images. In an embodiment, each party will be able to edit the data that they own or have provided according to the workflow.

In one embodiment, the users may collaborate using a live telepathology system. With the live telepathology, the slide may be positioned on the microscope, such as the microscope optics 807 of the imager 801 of FIG. 9, during viewing and images may be delivered live to the remote user. Such a system may allow users to change capture conditions (e.g., x, y, and/or z position in the sample of the image being captured or other imaging criteria such as described herein) if a particular image does not contain desired information. Such a multitiered system with stored images may serve, in an embodiment, as the primary image data source. Live images may provide enhanced imaging capability and provide a comprehensive technologies platform.

The tools menu may also provide administration functions, which may be available system-wide but only to designated adminstrators. The administration functions may be employed to set up users in the system and assign them to application roles, such as to conduct primary or peer review related to a study.

The tools menu may also provide other options, which may be general application options local to an image interface 200 or other node and possibly restricted to one or more users.

The system may provide a study options menu, such as included on one or more of the displays 17-22, that may provide options a user may employ. For example, one study menu option may an option to create a new study. This function may be restricted to reviewers, such as primary and/or peer reviewers.

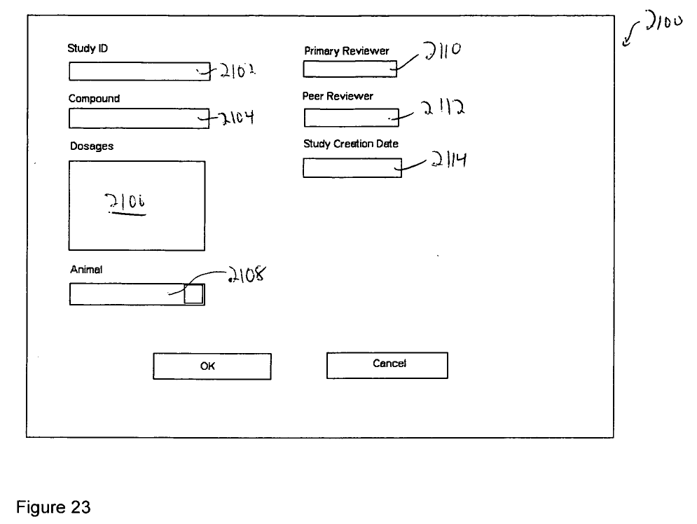

FIG. 23 illustrates an embodiment of a new study display 2100 that may be shown on a image interface 200 as described herein, for example. The display may include a modal dialog that may capture the following information or a portion thereof: study ID (e.g., from data capture system such as Xybion or Pathdata); compound; dosage levels (e.g., one or many); animal (choices are rat, mouse, dog, etc . . . ); primary reviewer (e.g., auto-generated); peer reviewer (e.g., auto-generated); date created (e.g., auto-generated); and notes generated by the user. That information may be captured in areas 2102, 2104, 2106, 2108, 2110, 2112, 2114, and 2116, respectively.

Another study menu option, which may be included on one or more of the displays 17-22, for example, may be a properties option employable to summarize study information. In one embodiment, this information may be editable by a creator (e.g., primary reviewer) and view-only to other reviewers and administrators.

Another study menu option, which may be included on one or more of the displays 17-22, for example, may be a post option employable by a primary reviewer or other user to alert the primary site administrator or other user to request a peer review from another site. In one embodiment, only a new study may be posted. The posting may request confirmation (e.g., with a prompt “Would you like to post this study?” Yes=post; No=cancel).

The status change regarding the study may be reflected in a study tree displayed in the study tree area 1510 of the home page display 1500 of FIG. 17 and/or in on or more other study trees.

Another study menu option, which may be included on one or more of the displays 17-22, for example, may be a request option for requesting a peer review of a study. For example, in one embodiment, after the posting of a new study by a primary reviewer, this request option may be used by the primary site administrator or another user to request a peer review from another site, such as through the network 991 of FIG. 11 or the network 1000 of FIG. 13. In an embodiment, a status change related to the study may be reflected in a study tree displayed in the study tree area 1510 of the home page display 1500 of FIG. 17 and/or in on or more other study trees.

Another study menu option, which may be included on one or more of the displays 17-22, for example, may be an assign option for assigning a peer reviewer to the study. For example, in an embodiment, in response to a request for a peer review, a peer site administrator may use the assign option to assign a peer reviewer to the study, and the status change related to the study may be reflected in the study tree area 1510 of the home page display 1500 of FIG. 17 and/or in on or more other study trees.

Another study menu option, which may be included on one or more of the displays 17-22, for example, may be a review option employable to indicate that the peer review has been completed. For example, in an embodiment, a peer reviewer may use the peer option to indicate (possibly in response to a displayed prompt) that the peer review has been completed, which may notify the primary reviewer to look at the peer findings and start the harmonization process. The status change related to the study may be reflected in the study tree area 1510 of the home page display 1500 of FIG. 17 and/or in on or more other study trees.

Another study menu option, which may be included on one or more of the displays 17-22, for example, may be a complete option employable to indicate that the study has been completed. In an embodiment, a primary reviewer may employ this option to close the study (possibly in response to a displayed prompt). The status change related to the study may be reflected in the study tree area 1510 of the home page display 1500 of FIG. 17 and/or in on or more other study trees. In one embodiment, when the study has been completed, the system, by default, expunges the peer findings.

The system may provide an image options menu, which may be included on one or more of the displays 17-22, for example, that may provide options a user may employ. For example, one image menu option may be an import option, which a user may employ to associate an image with a currently selected study. Functionality associated with this option may include image browsing and a search function that includes fields for entering metadata. In an embodiment, the search function includes functionality such as described with respect to the retrieval tool search display 1700 of FIG. 19.

The system may provide an import option display, which may be included on one or more of the displays 17-22, for example, and which may be associated with the import option. The import option display may be shown on an image interface 200 as described herein, for example. A user may enter information to associate an image of a slide with the actual glass or other slide. If the slide is already in the system through the data capture system (e.g. Xybion, Pathdata, etc), then only a slide ID may be entered. The system may then retrieve available data from the data capture system and populate the appropriate fields.

Images may be transported between sites via one or more of multiple methods including, for example: physical transport of media containing images, such hard drives, DVDs, etc.; on-demand image delivery, such as by way of a client/server system that manages the transport of images as they are requested; and FTP, HTTP, or similar en-block transfer system. The image transfer may be performed such as described herein.

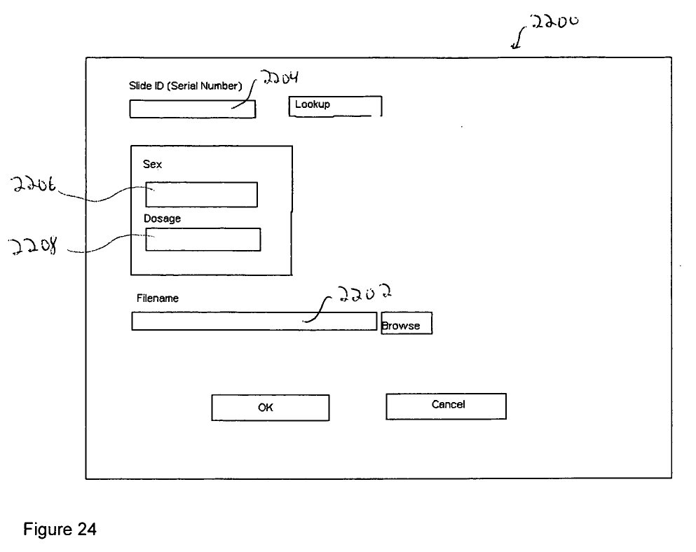

The system may include a file browse control display, such as the file browse control display 2200 of FIG. 24, in accordance with one embodiment. The file browse control display 2200 may be employed to find and retrieve an image file by various criteria, such as slide ID or serial number, sex of the animal from which the specimen was taken, dosage, for example. These criteria may be entered in criteria areas 2202 through 2208, respectively of the file browse control display 2200.

In an embodiment, slide images may be automatically imported. For example, a system administrator may set up, such as via the image system 799 of FIG. 9 or otherwise as described herein, an image importing function to run automatically upon image request receipt from a peer reviewer or upon peer review request by a primary reviewer. Images corresponding to cases requested may be automatically imported and transferred to the peer review site, such by way of a network such as the network 991 of FIG. 11 or the network 1000 of FIG. 13, and to an image interface 200 or other node.

Another image menu option may be an export option, which may be included on one or more of the displays 17-22, for example, employable to save a current image view as an image file (e.g., JPEG, TIFF, JPEG2000) for use with other programs. Another image menu option may be a delete option employable to delete a currently selected image, including input findings.

Another image menu option may be a compare option employable to show two selected images side-by-side.

FIG. 25 illustrates an embodiment of a compare option display 2300 that may be associated with the import option, in accordance with an embodiment, of a system such as the image system 799 of FIG. 9. A user may select two images from a study tree display, such as that of the study tree display 1705 of FIG. 19, or a search results tree display, such as the images only search results tree 1810, for example, and then select a compare function (not shown) the system may employ. Selecting the compare function may prompt the system to display images, such as the images 2302 and 2304 of the compare option display 2300, side-by-side or otherwise simultaneously. Each image may be independently navigated, such as via sets of the navigation buttons 2306 and 2308. In one embodiment, the navigation may be synchronized such that a user movement on one image executes the same move on the other image.

Navigation may be combined with an overlay mode where instead of the two images being displayed side-by-side, they are overlaid, one on top of the other. A user adjustable transparency factor for each image may be employable by a user to allow one image to come to the foreground or be sent to the background.

Areas of overlap may be indicated by unique color (such as bright red), for example, or other criteria. Overlap criteria may be user defined. If a certain area on both images contains the same color, then this may be considered an overlap and that area may be painted bright red on the image.

Another image menu option may be an annotation option that, when employed, allows a reviewer or other user to enter notes specific to a particular image view.

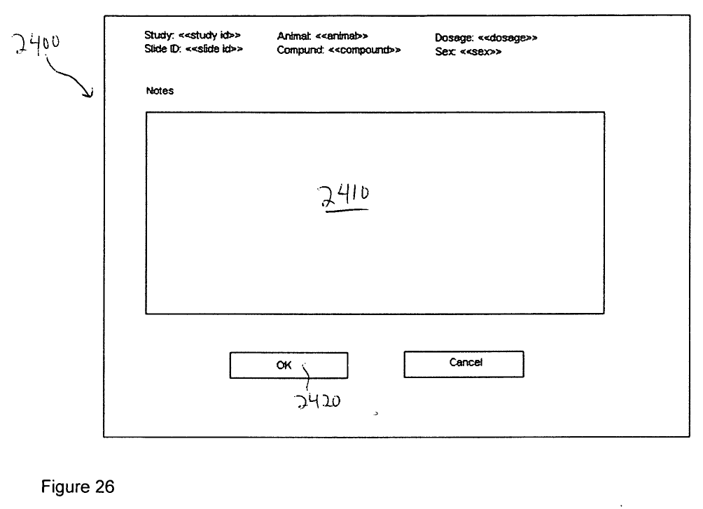

FIG. 26 illustrates an embodiment of the annotation option display 2400 associated with the annotation option, in accordance with an embodiment. The annotation option display 2400 may be shown on an image interface 200 as described herein, for example. The user may enter the annotation in the notes box 2410 and then press the OK button 2420 to prompt the system to process the annotation such that it is specific to a currently viewed image. For example, the system may associate the annotation with a specific resolution and coordinates displayed to the user, such as on the image interface 200.

Another image menu option, which may be included on one or more of the displays 17-22, for example, may be a quantify option employable to apply image analysis tools to an image to assist the reviewer or other user with grading of the specimen. Such image analysis tools may include, for example, tools that perform or facilitate cell count, nuclear to cytoplasmic ratio statistics, nuclear texture, etc. In an embodiment, this functionality of the quantify option may be combined with the annotation option described above so that quantify option may be applied to, or only to, an area defined by the annotation. Quantification data associated with this option may be stored with study data associated with the toxicology and risk assessment or other study.

Another image menu option, which may be included on one or more of the displays 17-22, for example, may be a measure option employable to allow a reviewer to apply manual measuring tools to an image. For example, in an embodiment, the measure option may be employed to prompt the system to automatically convert screen pixels of the image shown, for example, on an image interface 200 as described herein, to user definable physical units of measure such as microns.

Another image menu option, which may be included on one or more of the displays 17-22, for example, may be a properties option employable to display basic or other properties of the image such as, for example, height, width, compressed file size, raw file size, bits per pixel, etc.

The system may provide a findings options menu, which may be included on one or more of the displays 17-22, for example, that may provide options a user may employ. For example, one findings menu option may be an import option, which a user may employ to retrieve study findings from an external system (e.g., data capture system such as Xybion, Pathdata, etc., which may be included in the image system 799 of FIG. 9, for example).

Another image menu option, which may be included on one or more of the displays 17-22, for example, may be an export option employable to transmit final harmonized findings back to an external system (e.g., data capture system such as Xybion, Pathdata, etc., which may be included in the image system 799 of FIG. 9, for example).).

Another image menu option may be an add finding option, which may be included on one or more of the displays 17-22, for example, and may be employable to allow a reviewer to enter findings associated with a case and/or a slide. During review of case, a user may add the finding. The add finding option display may include a modal dialog and may be shown on an image interface 200 as described herein, for example. The user may enter a description of the findings regarding the case and/or slide in a findings box.

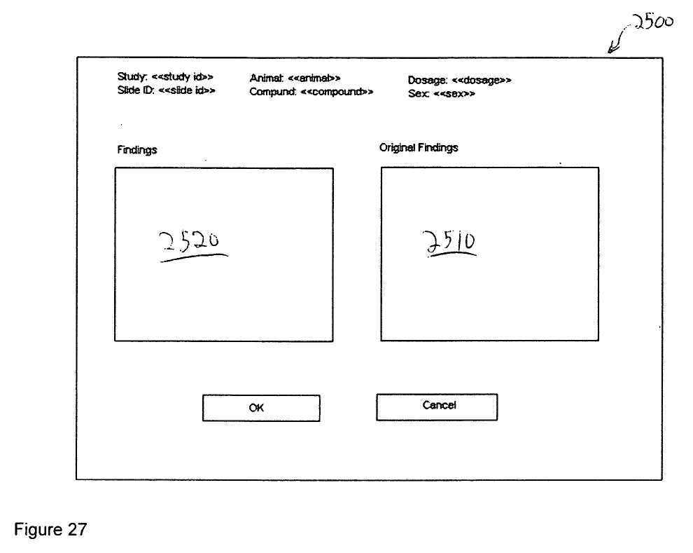

FIG. 27 illustrates an embodiment of a reconcile option display 2500, which may be employable to allow a primary reviewer to reconcile original findings with a peer reviewer. Employing this option may result in the display of primary findings 2510, peer findings 2520, and thumbnails of images (not shown) reviewed and possibly annotated by either or both the primary and peer reviewers. In one embodiment, the reconcile option may be used in conjunction with the collaboration function described above such that the peer and primary reviewers may collaborate to reconcile the displayed primary and peer findings, which may include review of any annotations or other information related to the thumbnailed images.

The system may provide reports menu options, which may be included on one or more of the displays 17-22, for example, and which may provide report options a user may employ. For example, one report option may be a study option, which a user may employ to summarize contents, findings, and a review status for one or more studies. Another reports menu option may be a status option employable to list active studies, by status. Another reports menu option may be a utilization option employable to summarize a peer review activity over a user-specified time period. Another report menu option may be an administration option employable to summarize sites, users, and roles, such as a description of the locations of slide images for studies, and a description of the system users and whether they are primary or peer reviewers or other users.

Another image menu option which may be included on one or more of the displays 17-22, for example, may be an audit option employable to trace an activity by study, user, site, etc. In an embodiment, the system may be set up for various degrees of performing and recording an audit trail. For example, the highest level of auditing may include recordation by the system of all activity of a user, such as buttons pressed, mouse movements, operating system log files from client or server computer, etc. Medium level auditing may include auditing user log on/log off as well as all events that result in data change or data release by the system (report, export, etc). Additional control may specify that data change only before and including data change before a study became ready for peer review status and after and including when the study had a completed status, such as described above. This additional control may be logged in the audit file and stored on the system, such as on an image server 850 such as described herein.

In an embodiment, this recorded user activity may become part of the study data associated with one or more specimen images of a toxicology and risk assessment study.

The system may provide a window options menu, which may be included on one or more of the displays 17-22, for example. The window options menu may include windows arrangement options that exist in standard windows applications such as an option that tiles open windows horizontally or vertically or opens a new window.

The system may provide a help options menu, which may be included on one or more of the displays 17-22, for example. A user may employ the peer review help option to launch and run a help file associated with the peer review application. Another help menu option may be an about peer review option, which a user may employ to view information such as application software version, copyright, support/contact information page, and other information.

In another embodiment, the above-described peer review system is used in conjunction with a remote telepathology slide viewing system such as MedMicro, manufactured and sold by Trestle Corporation of Irvine, Calif. Using this type of system, a peer reviewer at a remote site such as an image interface 200 as described herein, for example, may access slides, enter annotations/findings, and communicate with the image server 850 or other server or node at the primary review site over a wide area network, such as the network 991 of FIG. 11 or the network 1000 of FIG. 13.

For example, at the microscope end of such a system, an automated microscope may be attached to a standard PC running the remote slide viewing system. Once connected to the Internet, users may log onto and control the microscope from any image interface 200 or other node, such as by using a proprietary or other slide viewer and system. Images may appear on screen in real time or near real time, and the viewer may navigation viewing of the slide, such as, for example, by control the objective, focus, and illumination of the remotely located microscope.

In one embodiment, the system may be developed for microscopy, and may transmit images in 24-bit true color or other desirable image quality. Where the computers communicate through Internet Protocol (IP), the system may be used over the Internet or on any Local Area Network (LAN).

Use of such a system may allow users to bridge distributed facilities that include stored images and associated information on an image server 850 or 1020, for example. Use of such a system may allow users to construct digitized knowledge databases, conduct consultations over great distances in real time, and the like. Thus, for example, robotic telepathology systems may be particularly suitable in certain cases for use in conjunction with the foregoing peer review systems and methods. Incorporation of such telepathology systems into a peer review system such as described herein may be facilitated by software program application development.

An embodiment of an article of manufacture that may function when utilizing an image system includes a computer readable medium having stored thereon instructions which, when executed by a processor, cause the processor to depict user interface information. In an embodiment, the computer readable medium may also include instructions that cause the processor to accept commands issued from a user interface and tailor the user interface information displayed in accordance with those accepted commands.

In an embodiment, an image interface includes a processor that executes instructions and thereby causes the processor to associate at least two images of specimens taken from a single organism in a case. The at least two images may be displayed simultaneously or separately.

The execution of the instructions may further cause the processor to display the at least two images to a user when the case is accessed. The execution of the instructions may further cause the processor to formulate a diagnosis from the at least two images in the case. The execution of the instructions may further cause the processor to distinguish areas of interest existing in one or more of the at least two images in the case.

The execution of the instructions may further cause the processor to associate information related to the at least two images with the case. The information may include a first diagnosis. The first diagnosis may be available to a second diagnoser who formulates a second diagnosis, and the executing of the instructions may further cause the processor to associate the second diagnosis with the case. The identity of a first diagnoser who made the first diagnosis may not be available to the second diagnoser. The first and second diagnoses and the identities of the first and second diagnosers who made the first and second diagnoses may be available to a user. The user may determine whether the first and second diagnoses are in agreement. The processor may execute instructions that further cause the processor to determine whether the first and second diagnoses are in agreement. The first diagnosis and the identity of a first diagnoser who made the first diagnosis may not be available to a second diagnoser who formulates a second diagnosis, and the execution of the instructions may further cause the processor to associate the second diagnosis with the case. The identities of the first and second diagnosers who made the first and second diagnoses may not be available to a user.

In an embodiment, a database structure associates at least two images of specimens taken from a single organism in a case.

In an embodiment, a method of organizing a case includes associating at least two images of specimens taken from a single organism in the case, and providing access to the associated at least two images through an image interface.

In an embodiment, an article of manufacture includes a computer readable medium that includes instructions which, when executed by a processor, cause the processor to associate at least two images of specimens taken from a single organism in a case.

In an embodiment, an image verification method includes: resolving whether a first image of a specimen is accepted or rejected for use in diagnosis; forwarding, if the first image is accepted, the first image to a diagnoser; forwarding, if the first image is rejected, the first image to an image refiner, the image refiner altering at least one parameter related to image capture; capturing, if the first image is rejected, a second image of the specimen, with the at least one parameter altered with respect to the capture of the second image; and forwarding, if the second image is captured, the second image to the diagnoser. The diagnoser may be a human diagnostician or a diagnostic device. The image refiner may be a human diagnostician or a diagnostic device. The image verification method may further include resolving whether the second image is accepted or rejected for use in diagnosis.

In an embodiment, an image verification device includes a processor having instructions which, when executed, cause the processor to: resolve whether a first image of a specimen is accepted or rejected for use in diagnosis; forward, if the first image is accepted, the first image to a diagnoser; forward, if the first image is rejected, the first image to an image refiner, the image refiner altering at least one parameter related to image capture; capture, if the first image is rejected, a second image of the specimen, with the at least one parameter altered with respect to the capture of the second image; and forward, if the second image is captured, the second image to the diagnoser.

In an embodiment, an article of manufacture includes a computer readable medium that includes instructions which, when executed by a processor, cause the processor to: resolve whether a first image of a specimen is accepted or rejected for use in diagnosis; forward, if the first image is accepted, the first image to a diagnoser; forward, if the first image is rejected, the first image to an image refiner, the image refiner altering at least one parameter related to image capture; capture, if the first image is rejected, a second image of the specimen, with the at least one parameter altered with respect to the capture of the second image; and forward, if the second image is captured, the second image to the diagnoser.

While the systems, apparatuses, and methods of utilizing a graphic user interface in connection with specimen images have been described in detail and with reference to specific embodiments thereof, it will be apparent to one skilled in the art that various changes and modifications can be made therein without departing from the spirit and scope thereof. Thus, it is intended that the modifications and variations be covered provided they come within the scope of the appended claims and their equivalents.

What is claimed is:

1. A system for a toxicology and risk assessment study, comprising:
a storage device to store a specimen image and study data related to the specimen image; and
a processor that executes instructions and thereby causes the processor to associate the specimen image with the study data.

2. The system of claim 1, wherein the study data comprises primary review findings.

3. The system of claim 2, wherein the study data further comprises peer review findings.

4. The system of claim 1, wherein the study data comprises quantification information.

5. The system of claim 1, wherein the study data comprises user activity associated with the toxicology and risk assessment study.

6. The system of claim 5, wherein the user activity was obtained by an audit.

7. The system of claim 1, wherein the study data comprises one or more parameters for the toxicology and risk assessment study.

8. The system of claim 7, wherein the one or more parameters comprises a sex of an animal from which the specimen was taken.

9. The system of claim 7, wherein the one or more parameters comprises a dosage group.

10. The system of claim 7, wherein the one or more parameters comprises a species type.

11. The system of claim 7, wherein the one or more parameters comprises a specimen type.

12. The system of claim 11, wherein the specimen type is tissue.

13. The system of claim 1, wherein the processor is further caused to associate an other toxicology and risk assessment study with the specimen image and the study data.

14. The system of claim 13, wherein the association of the other toxicology and risk assessment study comprises association of an other specimen image and other study data from the other toxicology and risk assessment study.

15. The system of claim 13, wherein the other toxicology and risk assessment study is associated by execution of a search request.

16. An article of manufacture comprising a computer readable medium that includes instructions which, when executed by a processor, cause the processor to:
associate a specimen image with toxicology and risk assessment study data related to the specimen image;
designate a user as a reviewer; and
designate a portion of the study data as inaccessible by the user.

17. The article of manufacture of claim 16, wherein the reviewer is a primary reviewer.

18. The article of manufacture of claim 16, wherein the reviewer is a peer reviewer.

19. The article of manufacture of claim 18, wherein the study data comprises primary review findings.

20. The article of manufacture of claim 16, wherein the portion of the study data comprises a dosage group.

21. The article of manufacture of claim 16, wherein the portion of the study data comprises an annotation.

22. An article of manufacture comprising a computer readable medium that includes instructions which, when executed by a processor, cause the processor to:
associate a multiplicity of images of specimens, at least two of the images being from different dosage groups of a toxicology and risk assessment study; and
display the at least two images from the different dosage groups to a user simultaneously.

23. The article of manufacture of claim 22, wherein the user is a primary reviewer.

24. The article of manufacture of claim 22, wherein the user is a peer reviewer.

25. An article of manufacture comprising a computer readable medium that includes instructions which, when executed by a processor, cause the processor to:
associate a multiplicity of images of specimens of a toxicology and risk assessment study, at least one of the images being from a dosage group and at least one other of the images being from a control group; and
display the at least one image from the control group and the at least one other image from the control group to a user simultaneously.

26. The article of manufacture of claim 25, wherein the user is a primary reviewer.

27. The article of manufacture of claim 25, wherein the user is a peer reviewer.

28. A system for a toxicology and risk assessment study, comprising:
means for storing a specimen image and study data related to the specimen image; and
means for associating the specimen image and the study data.

29. The system of claim 28, further comprising means for displaying at least a portion of the specimen image and the study data.
